(19) United States
(12) Patent Application Publication
(10) Pub. No.: US 2024/0256227 A1
(43) Pub. Date: Aug. 1, 2024

(54) SOFTWARE ROBOTS WITH CHANGE DETECTION FOR UTILIZED APPLICATION PROGRAMS

(71) Applicant: Automation Anywhere, Inc., San Jose, CA (US)

(72) Inventors: Gaurangkumar PATEL, Fremont, CA (US); Murali Mohan PALLIKONDA, San Jose, CA (US); Harshil LODHIYA, Vadodara (IN)

(21) Appl. No.: 18/215,132

(22) Filed: Jun. 27, 2023

Related U.S. Application Data
(60) Provisional application No. 63/442,092, filed on Jan. 30, 2023.

(51) Int. Cl. G06F 8/30

(52) U.S. Cl. CPC G06F 8/30

(57) ABSTRACT

Systems and methods for evaluating whether software robots need to be updated due to changes in underlying application programs upon which the software robots operate. According to one embodiment, during creation of a software robot, a fingerprint for a screen of an application program being utilized by the software robot can be generated and stored. Then, later during execution of the software robot, a fingerprint for the screen of the application program can be again generated and compared with the stored fingerprint. If the fingerprints do not match, then the screen of the application program can be determined to have changed. When one or more of the screens of the application program have changed, the software robot may no longer execute correctly with the application program. In such case, the system and method can recommend that that the software robot be recreated.

### CROSS-REFERENCE TO RELATED APPLICATION

This application claims priority to U.S. Provisional Patent Application No. 63/442,092, filed Jan. 30, 2023, and entitled “SOFTWARE ROBOTS WITH CHANGE DETECTION FOR UTILIZED APPLICATION PROGRAMS,” which is hereby incorporated by reference herein.

### BACKGROUND OF THE INVENTION

Robotic process automation (RPA) systems enable automation of repetitive and manually intensive computer-based tasks. In an RPA system, computer software, namely a software robot (often referred to as a “bot”), may mimic the actions of a human user in order to perform various computer-based tasks. For instance, an RPA system can be used to interact with one or more software applications through user interfaces, as a human user would do. Therefore, RPA systems typically do not need to be integrated with existing software applications at a programming level, thereby eliminating the difficulties inherent to integration. Advantageously, RPA systems permit automation of application-level repetitive tasks via software robots that are coded to repeatedly and accurately perform the repetitive tasks.

Unfortunately, however, interacting with one or more software applications through user interfaces by software robots during their execution, as a human user would do. can be problematic when the user interfaces of the software applications are changed because execution of the software robots will often fail. Therefore, there is a need for improved approaches to detect changes to software applications so that RPA systems are able to operate software robots with increased reliability and flexibility.

### SUMMARY

Systems and methods for evaluating whether software robots need to be updated due to changes in underlying application programs upon which the software robots operate are disclosed. According to one embodiment, during creation of a software robot, a fingerprint for a screen of an application program being utilized by the software robot can be generated and stored. Then, later during execution of the software robot, a fingerprint for the screen of the application program can be again generated and compared with the stored fingerprint. If the fingerprints do not match, then the screen of the application program can be determined to have changed. When one or more of the screens of the application program have changed, the software robot may no longer execute correctly with the application program. In such case, the system and method can provide a notification, such as to a user. The notification can, for example, recommend that that the software robot be recreated.

The invention can be implemented in numerous ways, including as a method, system, device, apparatus (including computer readable medium and graphical user interface). Several embodiments of the invention are discussed below.

As a computer-implemented method for detecting changes in one or more application programs that are utilized by a software robot, one embodiment can, for example, include at least: forming a software robot that utilized at least one application program, wherein the software robot initiates interactions with the at least one application program on behalf of a user; generating a design-time fingerprint associated with an application screen of the at least one application program that occurs during the forming of the software robot; saving the software robot; saving the design-time fingerprint in association with saved software robot; subsequently starting execution of the software robot; detecting presentation of an application screen of the at least one application program during execution of the software robot; generating an execution-time fingerprint associated with the application screen of the at least one application program during execution of the software robot, if the detecting detects presentation of the application screen of the at least one application program during execution of the software robot; comparing the execution-time fingerprint with the design-time fingerprint to produce comparison data; and determining whether the at least one application program has changed based on the comparison data.

As a computer-implemented method for detecting changes in an application program being utilized by a software robot during execution of the software robot, the software robot being supported by a robotic process automation system, one embodiment can, for example, include at least: starting execution of the software robot; detecting presentation of an application screen of the application program during execution of the software robot; generating an execution application fingerprint associated with the application screen of the application program during execution of the software robot, if the detecting detects presentation of the application screen of the application program during execution of the software robot; retrieving a saved application fingerprint that was previously saved for a corresponding application screen of the application program; comparing the execution application fingerprint with the saved application fingerprint to produce comparison data; and determining whether the application program has changed based on the comparison data.

As a non-transitory computer readable medium including at least computer program code tangible stored therein for detecting changes in an application program being utilized by a software robot during execution of the software robot, one embodiment can, for example, include at least: computer program code for initiating execution of the software robot; computer program code for detecting presentation of an application screen of the application program during execution of the software robot; computer program code for generating an execution application fingerprint associated with the application screen of the application program during execution of the software robot, if the detecting detects presentation of the application screen of the application program during execution of the software robot; computer program code for retrieving a saved application fingerprint that was previously saved for a corresponding application screen of the application program; computer program code for comparing the execution application fingerprint with the saved application fingerprint to produce comparison data; and computer program code for determining whether the application program has changed based on the comparison data.

As a computer-implemented method for determining whether a software robot needs to be updated, one embodiment can, for example, include at least: detecting presentation of an application screen of the application program during execution of the software robot; generating an execution application fingerprint associated with the application screen of the application program during execution of the software robot, if the detecting detects presentation of the application screen of the application program during execution of the software robot; retrieving a saved application fingerprint that was previously saved for a corresponding application screen of the application program; comparing the execution application fingerprint with the saved application fingerprint to produce comparison data; and determining whether the application program has changed based on the comparison data.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a block diagram of a programmatic automation environment according to one embodiment.

FIG. 2 is a block diagram of a computing environment according to one embodiment.

FIG. 3 is a flow diagram of an execution process according to one embodiment of the invention.

FIG. 4 is a flow diagram of a change detection process according to one embodiment.

FIG. 5 is a flow diagram of a software robot formation process according to one embodiment.

FIG. 6 is a flow diagram of a notification process according to one embodiment.

FIG. 7A is a flow diagram of a fingerprint generation process according to one embodiment.

FIG. 7B illustrates a supported elements table according to one embodiment.

FIGS. 7C and 7D illustrates a flow diagram of a fingerprint comparison process according to one embodiment.

FIG. 7E illustrates an exemplary user interface screen that has been produced by an underlying application program during creation of a software robot (e.g., bot).

FIG. 7F illustrates an exemplary user interface screen that has been produced by an underlying application program execution of a previously created software robot.

FIG. 7G illustrates an exemplary user interface screen that has been produced by an underlying application program execution of a previously created software robot.

FIG. 7H illustrates an exemplary user interface screen that has been produced by an underlying application program execution of a previously created software robot.

FIG. 8 is a block diagram of a robotic process automation system according to one embodiment.

FIG. 9 is a block diagram of a generalized runtime environment for bots in accordance with another embodiment of the robotic process automation system illustrated in FIG. 8.

FIG. 10 is yet another embodiment of the robotic process automation system of FIG. 8 configured to provide platform independent sets of task processing instructions for bots.

FIG. 11 is a block diagram illustrating details of one embodiment of the bot compiler illustrated in FIG. 10.

FIG. 12 is a block diagram of an exemplary computing environment for an implementation of a robotic process automation system.

### DETAILED DESCRIPTION OF CERTAIN EMBODIMENTS

Systems and methods for evaluating whether software robots need to be updated due to changes in underlying application programs upon which the software robots operate are disclosed. According to one embodiment, during creation of a software robot, a fingerprint for a screen of an application program being utilized by the software robot can be generated and stored. Then, later during execution of the software robot, a fingerprint for the screen of the application program can be again generated and compared with the stored fingerprint. If the fingerprints do not match, then the screen of the application program can be determined to have changed. When one or more of the screens of the application program have changed, the software robot may no longer execute correctly with the application program. In such case, the system and method can provide a notification, such as to a user. The notification can, for example, recommend that that the software robot be recreated.

Generally speaking, RPA systems use computer software to emulate and integrate the actions of a human interacting within digital systems. In an enterprise environment, the RPA systems are often designed to execute a business process. In some cases, the RPA systems use artificial intelligence (AI) and/or other machine learning capabilities to handle high-volume, repeatable tasks that previously required humans to perform. The RPA systems also provide for creation, configuration, management, execution, and/or monitoring of software automation processes.

A software automation process can also be referred to as a software robot, software agent, or bot. A software automation process can interpret and execute tasks on one's behalf. Software automation processes are particularly well suited for handling a lot of the repetitive tasks that humans perform every day. Software automation processes can accurately perform a task or workflow they are tasked with over and over. As one example, a software automation process can locate and read data in a document, email, file, or window. As another example, a software automation process can connect with one or more Enterprise Resource Planning (ERP), Customer Relations Management (CRM), core banking, and other business systems to distribute data where it needs to be in whatever format is necessary. As another example, a software automation process can perform data tasks, such as reformatting, extracting, balancing, error checking, moving, copying, or any other desired tasks. As another example, a software automation process can grab data desired from a webpage, application, screen, file, or other data source. As still another example, a software automation process can be triggered based on time or an event, and can serve to take files or data sets and move them to another location, whether it is to a customer, vendor, application, department or storage. These various capabilities can also be used in any combination. As an example of an integrated software automation process making use of various capabilities, the software automation process could start a task or workflow based on a trigger, such as a file being uploaded to an FTP system. The integrated software automation process could then download that file, scrape relevant data from it, upload the relevant data to a database, and then send an email to a recipient to inform the recipient that the data has been successfully processed.

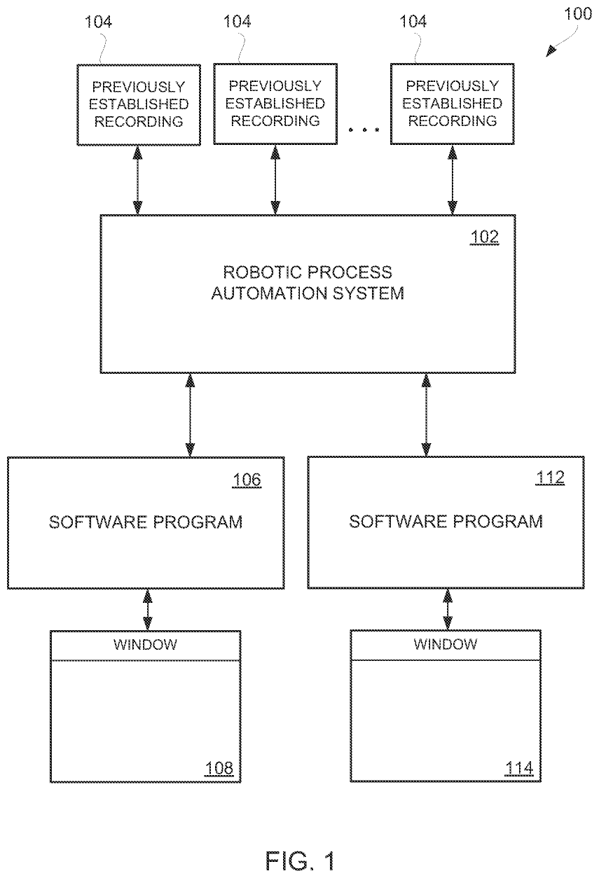

Embodiments of various aspects of the invention are discussed below with reference to FIGS. 1-12. However, those skilled in the art will readily appreciate that the detailed description given herein with respect to these figures is for explanatory purposes as the invention extends beyond these limited embodiments.

FIG. 1 is a block diagram of a programmatic automation environment 100 according to one embodiment. The programmatic automation environment 100 is a computing environment that supports RPA. The computing environment can include or make use of one or more computing devices. Each of the computing devices can, for example, be an electronic device having computing capabilities, such as a mobile phone (e.g., smart phone), tablet computer, desktop computer, portable computer, server computer, and the like.

The programmatic automation environment 100 serves to support recordation of a series of user interactions of a user with one or more software programs operating on a computing device, and then to enable a software automation process to subsequently provide programmatic “playback” of the series of user interactions with the same one or more software programs operating on the same or different computing device. The recordation of the series of user interactions forms a recoding. The recording defines or describes the user interactions that are to be mimicked by a software automation process. Programmatic playback of a recording refers to the notion that the playback is undertaken by a software automation program, as opposed to a user.

The programmatic automation environment 100 includes an RPA system 102 that provides the robotic process automation. The RPA system 102 supports a plurality of different robotic processes, which can be denoted as software automation processes. These software automation processes can also be referred to as “software robots,” “bots” or “software bots.” More particularly, in one embodiment, the software automation processes are defined or described by respective recordings, namely, previously established recordings 104 as shown in FIG. 1. The RPA system 102 can create, maintain, execute, and/or monitor recordings, including the previously established recordings 104, to carry out software automation processes. The RPA system 102 can also report status or results of software automation processes.

The RPA system 102 supports creation and storage of software automation processes. In the simplified block diagram shown in FIG. 1, the RPA system 102 can support a recording session in which a series of user interactions with one or more software programs (e.g., application programs) operating on a computing device can be recorded. In general, recording of a software automation process refers to recording or capturing the steps or processes performed in order to complete tasks, which can inform the process of creating software automation process. The series of user interactions can then be utilized by the RPA system 102 to form a software automation process (e.g., bot) for carrying out such actions in an automated manner. The RPA utilization environment 100 can also store the software automation processes (e.g., bots) that have been created.

In addition, the RPA system 102 further supports the execution of the one or more software automation processes that have been created by the RPA system 102 or some other RPA system. Execution (or running) of a software automation process at a computing device causes playback of the software automation process. That is, when a software automation process is executed or run by one or more computing devices, the software automation process is being “played back” or undergoing “playback”, meaning the software automation process programmatically performs actions similar to, or the same as, the steps that were captured in a recording. Advantageously, the RPA system 102 supports the playback of software automation processes in a more reliable manner.

On execution of a software automation program that is at least partially based on one or more of the previously established recordings 104, the software automation program, via the RPA system 102, can interact with one or more software programs 106. One example of the software program 106 is an application program. The application programs can vary widely with user's computer system and tasks to be performed thereon. For example, application programs being used might be word processing programs, spreadsheet programs, email programs, ERP programs, CRM programs, web browser programs, any many more. The software program 106, when operating, typically interacts with one or more windows 108. For example, a user interface presented within the one or more windows 108 can be programmatically interacted with through execution of the one or more software automation processes 104. The one or more windows are typically displayed on a display device.

In some cases, the software program 106 is seeking to access documents that contain data that is to be extracted and then suitably processed. The documents are typically digital images of documents, which are presented in the one or more windows 108. The RPA system 102 can include processing and structures to support the extraction of data from such document images. Some examples of documents to be accessed include emails, web pages, forms, invoices, purchase orders, delivery receipts, bill of lading, insurance claims forms, loan application forms, tax forms, payroll reports, medical records, etc.

When robotic process automation operations are being performed, the RPA system 102 seeks to interact with the software program 106. However, since the RPA system 102 is not integrated with the software program 106, the RPA system 102 requires an ability to understand what content is contained in the window 108. For example, the content being presented in the window 108 can pertain to a graphical user interface or a document. In this regard, the RPA system 102 interacts with the software program 106 by interacting with the content in the window 108. By doing so, the software automation process being carried out, via the RPA system 102, can effectively interface with the software program 106 via the window 108 as would a user, even though no user is involved because the actions detailed in the previously established recording 104 for the software automation process are programmatically performed. Once the content of the window 108 is captured and understood, the RPA system 102 can perform an action requested by the previously established recording 104 by inducing action with respect to the software program 106.

Likewise, when robotic process automation operations are being performed, the RPA system 102 can also seek to interact with the software program 112, which can be another application program. However, since the RPA system 102 is not integrated with the software program 112, the RPA system 102 requires an ability to understand what content is being presented in window 114. For example, the content being presented in the window 114 can pertain to user interface or a document. In this regard, the RPA system 102 interacts with the software program 112 by interacting with the content in the window 114 corresponding to the software program 112. By doing so, the software automation process being carried out, via the RPA system 102, can effectively interface with the software program 112 via the window 114 as would a user, even though no user is involved because the actions detailed in the previously established recording 104 for the software automation process are programmatically performed. Once the content of the window 114 is captured and understood, the RPA system 102 can perform an action requested by the previously established recording 104 by inducing action with respect to the software program 112.

The RPA system 102 further supports checking for changes to the software programs 106, 112 during the execution of the software automation process. The checking for changes during the execution of software automation processes allows for recognition that changes to one or more of the software programs 106, 112 have occurred. The changes being detected are changes to the software programs since the recording for the software automation process was originally made. For example, the changes being detected can be changes to one or more graphical user interfaces produced by a software program. When changes are detected to an underlying software program, the changes can be evaluated to determine whether a notification is needed, and whether the software automation process should be updated or re-created so that it will execute properly.

Additional details on detection of controls from images according to some embodiments are provided in (i) U.S. patent application Ser. No. 16/527,048, filed Jul. 31, 2019, and entitled “AUTOMATED DETECTION OF CONTROLS IN COMPUTE®APPLICATIONS WITH REGION BASED DETECTORS,” which is hereby incorporated by reference herein by reference for all purposes; and (ii) U.S. patent application Ser. No. 16/876,530, filed May 18, 2020, and entitled “DETECTION OF USER INTERFACE CONTROLS VIA INVARIANCE GUIDED SUB-CONTROL LEARNING,” which is hereby incorporated herein by reference for all purposes.

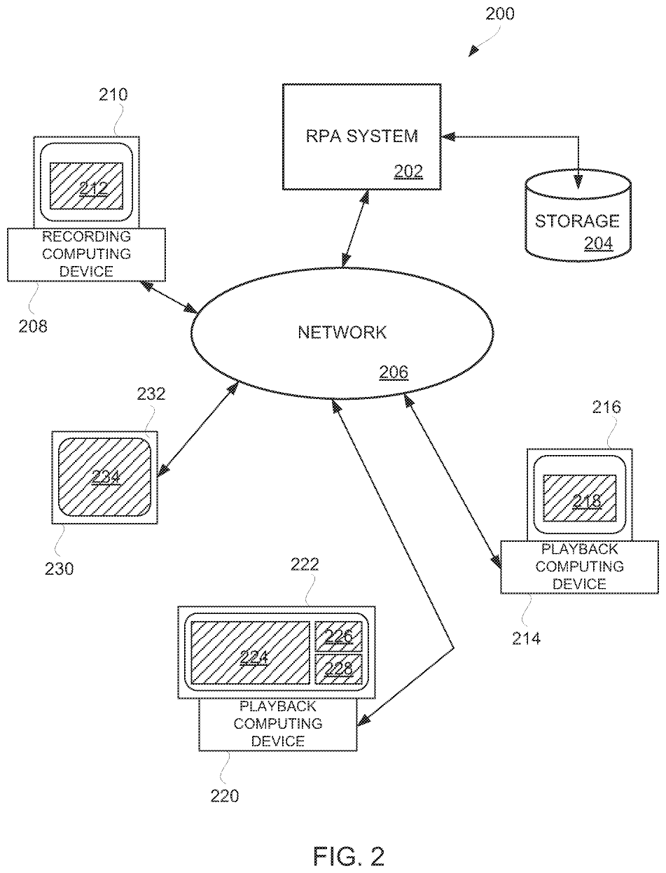

FIG. 2 is a block diagram of a computing environment 200 according to one embodiment. The computing environment 200 includes an RPA system 202. The RPA system 202 is, for example, similar to the RPA system 102 illustrated in FIG. 1. The RPA system 202 can be coupled to a storage 204 for storage of software automation processes (e.g., bots).

Additionally, the computing environment 200 can support various different types of computing devices that can interact with the RPA system 202. The computing environment 200 can also include or couple to a network 206 made up of one or more wired or wireless networks that serve to electronically interconnect various computing devices for data transfer. These computing devices can serve as a recording computing device, a playback computing device, or both. As shown in FIG. 2, the computing environment 200 can include a recording computing device 208 that includes a display device 210 and a window 212 presented on the display device 210. The window 212 can, in one example, depict a user interface that is associated with recording user interactions with one or more application programs to produce a software automation process using the RPA system 202.

The computing environment 200 shown in FIG. 2 can also include various playback computing devices. A first playback computing device 214 includes a display device 216 that can present a window 218. A second playback computing device 220 includes a display device 222 that can present a first window 224, a second window 226 and a third window 228. A third playback computing device 230 includes a display device 232 that can present a window 234. More generally, the windows are screens that are presented and visible on respective display devices. Of course, the recording computing device 208 can also operate as a playback computing device.

The different playback computing devices 214, 220 and 230 can all execute software programs that were previously created. However, a software automation process might have been created to interact with a former version of a software program, and then subsequently, when executed, seek to interact with a newer version of the same software program. In some cases, the changes to the software program or to its corresponding graphical user interface (e.g., window) can cause execution (i.e., playback) of the software automation process to fail to properly execute. For example, if a newer version of a software application changes its user interface such that a particular interface user interface control (e.g., a send button) is repositioned or eliminated, then the software automation process would be unable to select the particular interface control because it would not know that the particular user interface control (e.g., the send button) has been repositioned or eliminated, and thus the desired automation would likely fail. Advantageously, by monitoring for changes to software programs during execution of a software automation process, changes to the software programs can be detected and a notification can be provided, such that interested persons or systems can be alerted as to a need to alter or re-create that software automation process.

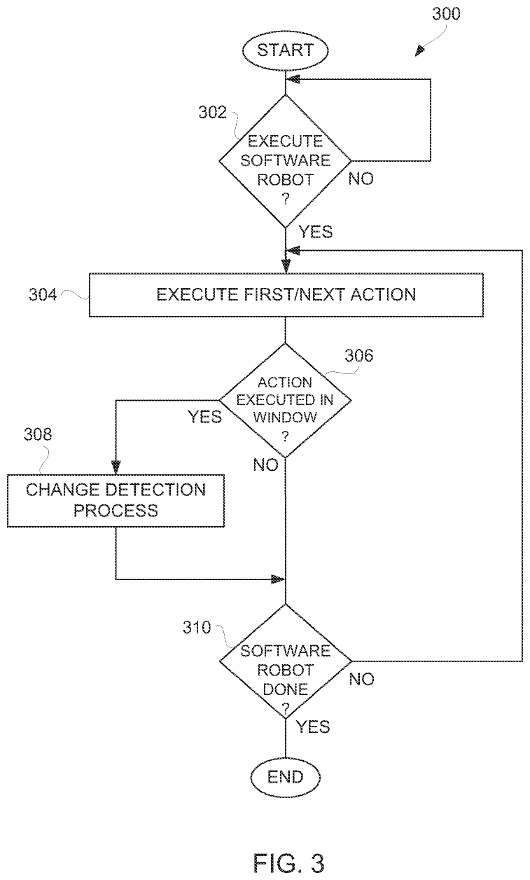

FIG. 3 is a flow diagram of an execution process 300 according to one embodiment of the invention. The execution process 300 can, for example, be performed by a computing device. The execution process 300 operates to execute a software robot and to check for changes to software programs (e.g., application programs) being utilized by the software robot while the software robot is being executed.

The execution process 300 can begin with a decision 302 that determines whether a software robot is to be executed. As one example, an RPA system can cause or facilitate a software robot to be executed. As another example, a user, an event or a trigger could cause a software robot to be initiated. When the decision 302 determines that execution of a software robot is not being requested, then the execution process 300 can await a request to execute a software robot.

On the other hand, when the decision 302 determines that a software robot is to be executed, the execution process 300 can begin executing the software robot. In particular, during execution of the software robot, a first (or next action) of the software robot can be executed 304. A decision 306 can then determine whether the action being executed corresponds to a window, that is, the action is done with respect to or within a window. The window is typically displayed on a display device by an application program being utilized by the software robot. The window can also be referred to as a user interface screen. When the decision 306 determines that the action executed corresponds to a window, a change detection process 308 can be started. The change detection process 308 can operate to detect a change in the underlying application program that produced the window in which the action is being executed.

Following the change detection process 308, or directly following the decision 306 when the action being executed does not correspond to a window, a decision 310 can determine whether the software robot is done executing. When the decision 310 determines that the software robot is not done executing, then the execution process 300 can return to repeat the block 304 and subsequent blocks so that the execution process 300 can continue to execute the software robot by processing a next action of the software robot. Alternatively, when the decision 310 determines that the software robot is done executing, i.e., all of the actions within the software robot have executed, then the execution process 300 can end.

Accordingly, the execution process 300 operates to not only execute a software robot but also detect changes that have occurred to underlying application programs being utilized by the software robot. Advantageously, the execution process 300 can serve to identify a software robot that may need to be re-created or otherwise modified in view of the detected changes that have occurred to one or more of the underlying application programs since the software robot was created.

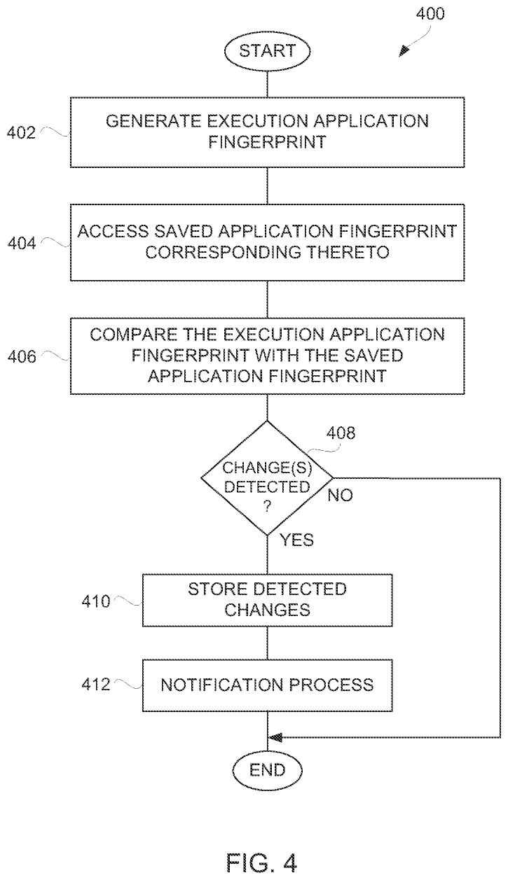

FIG. 4 is a flow diagram of a change detection process 400 according to one embodiment. The change detection process 400 can, for example, implement the change detection process 308 illustrated in FIG. 3.

The change detection process 400 can generate 402 an execution application fingerprint. For example, the execution application fingerprint can be a fingerprint corresponding to a user interface, such as a window (e.g., UI screen) of the application program utilized in the execution. The execution application fingerprint can, for example, be determined by identifying a set of elements within the user interface, then generating fingerprints for those elements, and then combining the elemental fingerprints into a combined fingerprint as the execution application fingerprint. The execution application fingerprint can also be referred to as an execution-time fingerprint.

Next, a saved application fingerprint corresponding to the execution application fingerprint can be accessed 404. In one embodiment, application fingerprints are saved within the software robot and are accessed therefrom. The saved application fingerprint is determined in the same manner as is the execution application fingerprint, but is typically when the software robot is created or designed. For example, the saved application fingerprint can, for example, be determined by identifying a set of elements within the user interface, then generating fingerprints for those elements, and then combining the elemental fingerprints into a combined fingerprint as the saved application fingerprint. The saved application fingerprint can also be referred to as a design-time fingerprint.

After the saved application fingerprint has been accessed 404, the execution application fingerprint can be compared 406 with the saved application fingerprint. Following the comparison 406, a decision 408 can determine whether one or more changes have been detected. Here, by comparing the execution application fingerprint with the saved application fingerprint, changes to user interfaces (e.g., UI screens or windows) of an application program can be detected. The changes being detected can, for example, detect the addition, removal or modification to objects (e.g., elements) within user interfaces of application programs. When changes to the user interfaces have been detected, the associated application program has necessarily been changed. When the decision 408 determines that one or more changes have been detected, the detected changes can be stored 410.

Thereafter, a notification process 412 can be performed. The notification process 412 can operate to notify a system or person of a concern that a software robot utilizing the associated application program may require updating given that one or more changes to the associated application program have been detected. The changes being detected in application programs may not have been known or previously communicated to users of the application programs, and the changes can negatively impact automation by the software robot being executed. Also, any addition or removal of elements being detected may show that the underlying user workflow automated by the software robot has changed.

Following the notification process 412, the change detection process 400 can end. Alternatively, when the decision 408 determines that no changes have been detected by comparing of the execution application fingerprint with the saved application fingerprint, the change detection process 400 can end.

In one embodiment, the notification process 412 can classify the changes being detected. The classification can indicate the seriousness of the changes being detected. If the classification indicates that the changes been detected are minor, there is likely no need for a notification to be provided to a system or person. On the other hand, if the classification indicates that the changes being detected are serious, then there is likely a need for a notification to a system or person, perhaps even a real-time notification.

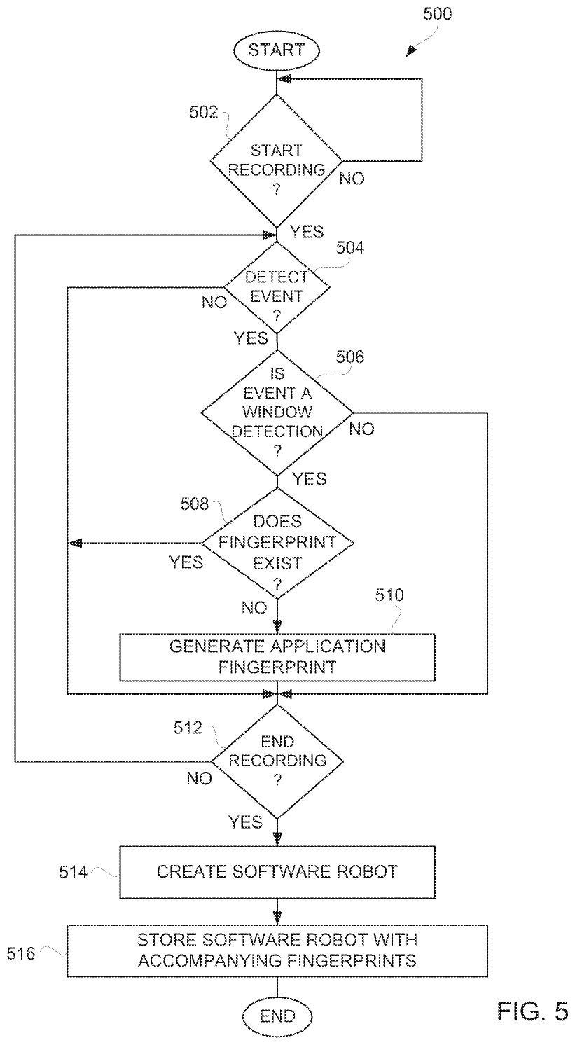

FIG. 5 is a flow diagram of a software robot formation process 500 according to one embodiment. The software robot formation process 500 is generally a process that forms or creates a software robot that can be used for robotic process automation. In this embodiment, the software robot is being formed or created using a recording process.

The software robot formation process 500 can begin with a decision 502 that determines whether a recording is to be started. When the decision 502 determines that recording has not yet been started, the software robot formation process 500 can await until a recording is to be started.

Once the decision 502 determines that recording is to be started, while recording, a decision 504 can determine whether an event has been detected. When the decision 504 determines that an event has been detected, a decision 506 can determine whether the event involves a window event wherein an interaction with a window of a software application occurs, e.g., when a user interacts with a GUI of the software application. A window detection operation can detect if and when a user interface window of an application program is used during the recording. When the decision 506 determines that the event involves a window event, then a decision 508 can determine whether a fingerprint already exist for that window. When the decision 508 determines that a fingerprint does not already exist for that window, then an application fingerprint for that window can be generated 510.

Also, the generation 510 of the application fingerprint need not be performed when the fingerprint is determined by the decision 508 to already exist or when the decision 506 determines that the event does not provide a window detection. Also, when the decision 504 determines that an event is not presently being detected, the software robot formation process 500 can also bypass the decision 506, the decision 508 and the block 510.

In any case, following the block 510 or its being bypassed, a decision 512 can determine whether the recording is to end. When the decision 512 determines that the recording is not concluded, then the processing operations at blocks 504 through 510 can be repeated as appropriate. On the other hand, when the decision 512 determines that the recording is to end, then the software robot formation process 500 can create 514 a software robot from the recording. Thereafter, the software robot can be stored 516 with accompanying fingerprints. The accompanying fingerprints are those fingerprints that have been generated 510 during the software robot formation process 500. Following the block 516, a software robot formation process 500 can and.

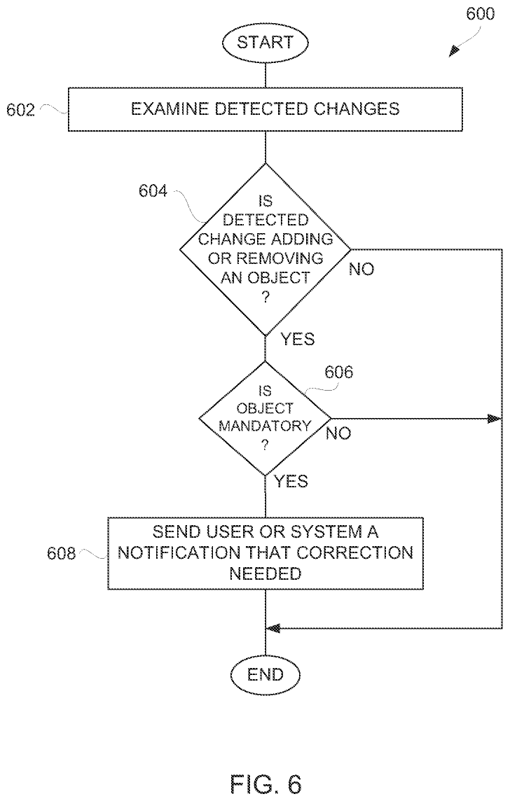

FIG. 6 is a flow diagram of a notification process 600 according to one embodiment. The notification process 600 can, for example, implement the notification process 412 illustrated in FIG. 4.

The notification process can examine 602 the detected changes. In one embodiment, the detected changes are at least in part provided on an object (e.g., element) level. The detected changes can, for example, indicate whether a particular object has been added, removed or altered with respect to the associated application program. Following the examination 602 of the detected changes, the notification process 600 can determine 604 whether the detected changes indicate addition or removal an object. In one embodiment, the adding of an object pertains to addition of a user interface element to a window (e.g., UI screen) of the application program, and the removal of an object pertains to removal of a user interface element from a window (e.g., UI screen) of the application program.

When the decision 604 determines that the detected change adds or removes an object, then a decision 606 can determine whether the object being added or removed is a mandatory object. In this regard, an object is deemed mandatory if the corresponding software robot that is interacting with the application program makes use of the object during execution of the software robot. When the decision 606 determines that the object being added or removed is a mandatory object, then a user or system making use of the software robot can be sent 608 a notification that correction to the software robot will be needed. In one implementation, the notification can visually present a representation of the detected changes that have occurred with respect to the underlying application program. In the same or another implementation, the notification and/or the data captured while detecting changes, can be modified to hide or blur any sensitive data that may be present.

On the other hand, when the decision 606 determines that the object being added or removed is not a mandatory object, or following the decision 604 when the decision 604 determines that the detected change does not add or remove an object, then the notification process 600 can directly end without providing a notification.

In one embodiment, the comparison of the fingerprints of the user interfaces of the application program can the done on an element-by-element basis. The fingerprint for a window (or UI screen) can be determined from a plurality of fingerprint for objects (e.g., elements) within the window (or UI screen). For example, the fingerprints for a given object can be derived from a set of properties for the object, and can then be combined together using a HASH function or JSON object. In one or more implementations, when such fingerprints are compared (e.g., string comparison), the comparison process can be established to identify exact matches between fingerprints, and/or to identify when fingerprints are deemed to match each other even though there may be some or slight differences, e.g., by using fuzzy logic comparison techniques.

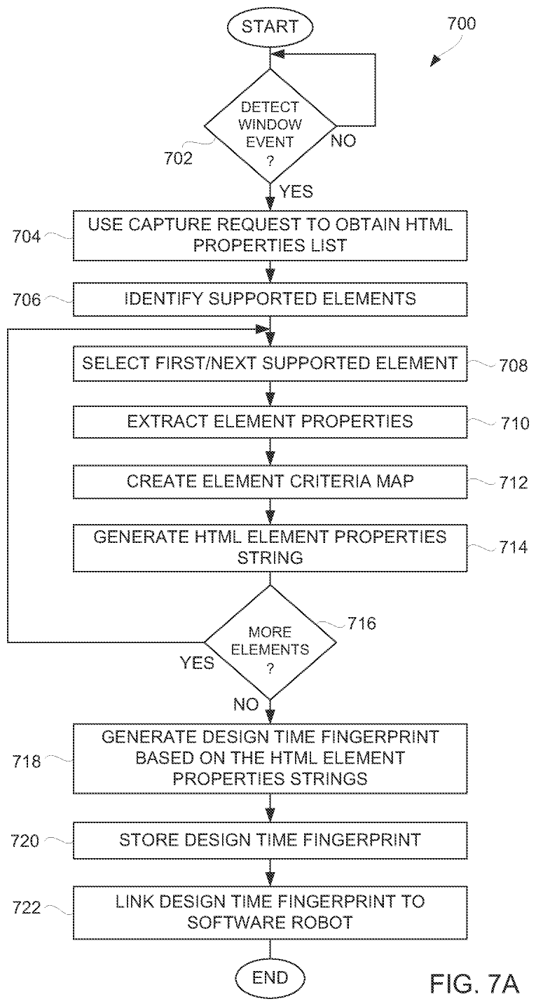

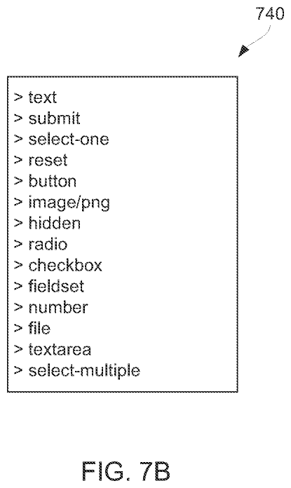

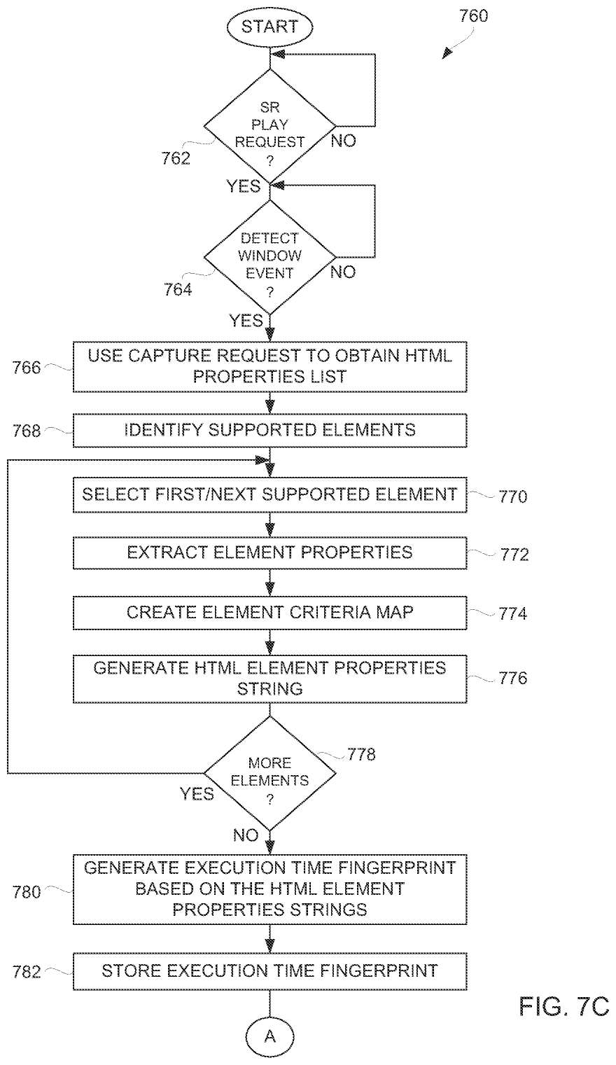

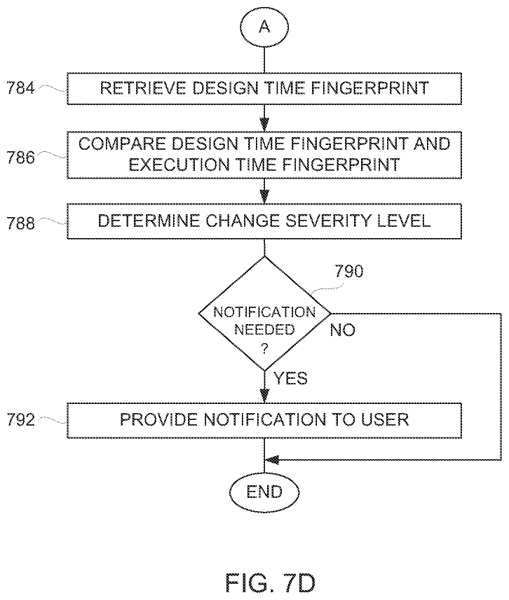

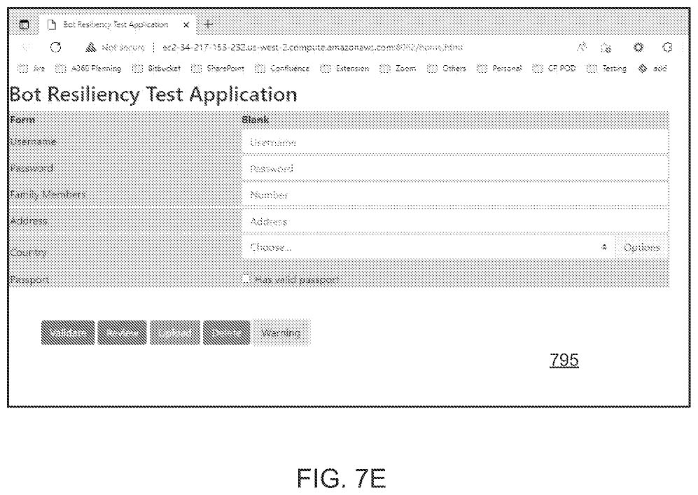

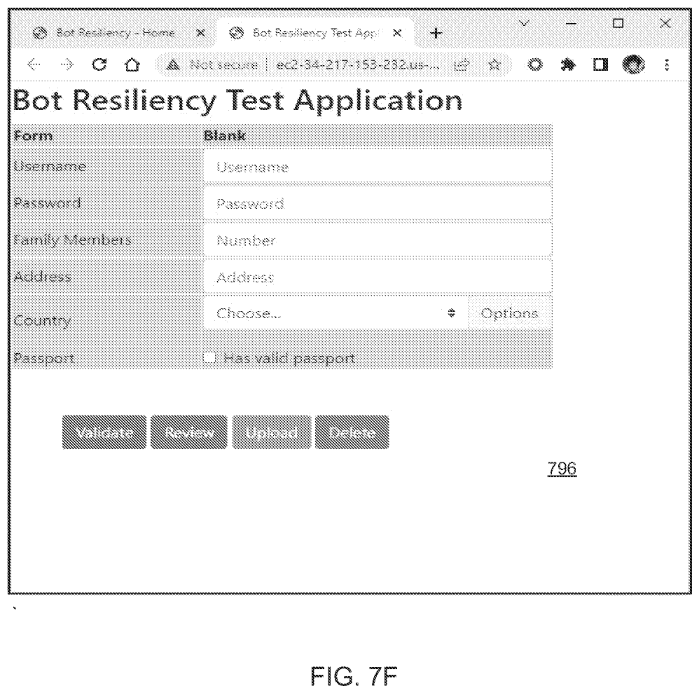

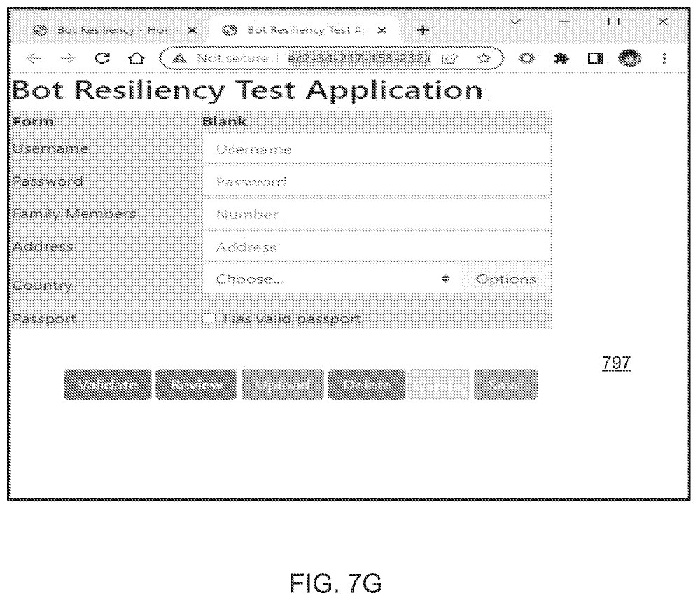

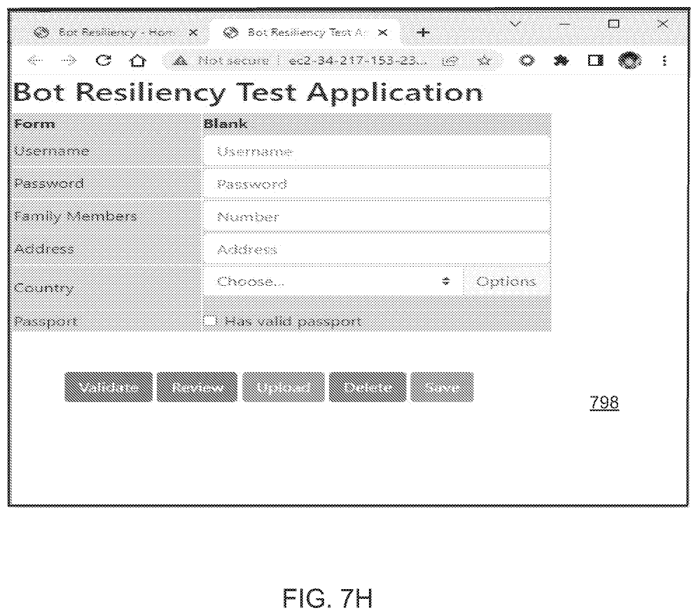

FIG. 7A is a flow diagram of a fingerprint generation process 700 according to one embodiment. The fingerprint generation process 700 is processing that is typically performed during creation of a software robot. In doing so, when window events are detected, processing can be performed to generate corresponding fingerprints. The fingerprints being generated during the creation of a software robot can later be used to evaluate whether changes to the underlying software application being utilized by the software robot has changed.

The fingerprint generation process 700 can begin with a decision 702 that determines whether a window event has been detected. When the decision 702 determines that window event has not yet been detected, the fingerprint generation process 700 can await such an event.

On the other hand, once the decision 702 determines that a window event has been detected, the fingerprint generation processing 700 can continue. Initially, a capture request can be used 704 to obtain and HTML properties list. The HTML properties list identifies available elements associated with the window event. Next, those of the available elements that are supported can be identified 706. Here, the software robot being created is typically for use with a robotic process automation system designed to support a subset of the available elements. The subset of available elements that are supported are referred to as supported elements.

Next, each of the supported elements can be processed. In this regard, initially, a first supported element is selected 708. The element properties for the supported element can then be extracted 710. These element properties can then be used to create 712 an element criteria map. Thereafter, an HTML element properties string can be generated 714. For example, the HTML element property string can be generated 714 from the element criteria map. The HTML element property string can be referred to as an element fingerprint. A criteria map is a unique element key that can be used in validating fingerprints. For example, if a key value changes, then it is considered to denote a changed element.

Next, a decision 716 can determine whether there are more supported elements to be processed. When the decision 716 determines that there are more supported elements to be processed, the fingerprint generation process 700 can return to repeat the block 708 and subsequent blocks so that a next supported element can be selected and similarly processed.

On the other hand, once the decision 716 determines that there are no more supported elements to be processed, a design time fingerprint can be generated 718 based on the HTML element properties strings. In one implementation, the various HTML element properties strings for the various supported elements can be combined together to form the design time fingerprint. For example, the various supported elements can be combined together in a JSON file to form the design time fingerprint. The design time fingerprint data has been generated 718 can then be stored 720 for subsequent retrieval. Additionally, the design time fingerprint can be linked 722 to the software robot being created. Following the block 722, the fingerprint generation process 700 can end.

As noted, the page fingerprint generation process 700 can be carried out during software robot creation. It should be understood that some of the terminology in FIG. 7A may pertain to HTML-type user interfaces, and that other types of application programs may use different terminology to reference its user interfaces but nevertheless operate in generally the same manner. These other types of application programs can, for example, be an application program from Microsoft Corporation, or SAP user interface, a JAVA application, and numerous others.

FIG. 7B illustrates a supported elements table 740 according to one embodiment. The supported elements table 740 corresponds to HTML elements that are supported. In various other implementations, different elements can be supported, wherein the elements involved depend on a supporting RPA system, underlying software application, and/or other factors. The supported elements table 740 lists a subset of elements of a user interface provided by an application program, according to one embodiment. In this example, the application program is a web-based application. Web-based applications tend to be customer driven, and thus are generally considered more dynamic than other types of applications. In this particular example, the web-based application includes HTML elements, and the subset of elements in the supported elements table 720 can be used in forming the fingerprints. It should be understood that other types of application programs will have different objects (e.g., elements) for its user interfaces.

FIGS. 7C and 7D illustrates a flow diagram of a fingerprint comparison process 760 according to one embodiment. The fingerprint comparison process 760 can be used during execution of a previously created software robot. By performing the fingerprint comparison process 760, the software robot itself can participate in the evaluating of whether the underlying one or more software applications being utilized by the software robot a change. In the event that changes to the one or more underlying software applications have been detected by the fingerprint comparison process 760, a user (or a RFA system) can be properly notified that the software robot may not operate correctly given the changes to the one or more underlying software applications.

The fingerprint comparison process 760 can begin with a decision 762 that determines whether a software robot (SR) play request has been detected. When the decision 762 determines that a software play request has not been detected, the fingerprint comparison process 760 can await such a request.

Alternatively, once the decision 762 determines that a software robot play request has been detected, the fingerprint comparison process 760 can perform processing to perform a fingerprint comparison. Initially, a decision 764 can determine whether a window event has been detected during the execution of the software robot. When the decision 764 determines that a window event has not been detected, the fingerprint comparison process 700 can continue to check for detection of a window event. On the other hand, once the decision 764 determines that a window event has been detected, the fingerprint comparison process 760 can use a capture request to obtain a HTML properties list. The HTML properties list includes a list of elements that are associated with the window event that has been detected (e.g., user interface). Next, those of the elements within the HTML properties list that are supported by the RPA system can be identified 768. These supported elements can then be processed as follows.

Initially, a first supported element can be selected 770. Then, for the selected element, element properties for the selected element can be extracted 772. An element criteria map can then be created 774 based on the extracted element properties. After the element criteria map has been created 774, an HTML element properties string can be generated 776 in accordance with the element criteria map. Next, a decision 778 can determine whether there are more supported elements to be processed. When the decision 778 determines that there are more supported elements to be processed, the fingerprint comparison process 760 can return to repeat the block 770 and subsequent blocks so that a next supported element can be selected 770 and similarly processed by block 772-776.

Alternatively, when the decision 778 determines that there are no more supported elements to be processed, an execution time fingerprint can be generated 780 based on the HTML element properties strings. The resulting execution time fingerprint can then be stored 782.

After the execution time fingerprint has been generated 780 and stored 782, the design time fingerprint corresponding to the software robot being executed can be retrieved 784. In one embodiment, the design time fingerprint associated with the software robot being executed can be provided with or linked to the software robot or its execution request. Following the retrieval 784 of the design time fingerprint, the fingerprint comparison process 700 can compare the design time fingerprint and the execution time fingerprint. The comparison 786 of the design time fingerprint to the execution time fingerprint is used to determine whether changes have occurred to user interfaces of underlying software applications being utilized by the software robot. If the comparison 786 determines that the execution time fingerprint matches, the design time fingerprint, then the comparison 786 indicates that the user interface of the underlying software applications have not likely changed. On the other hand, if the comparison 786 determines that the execution time fingerprint does not match the design time fingerprint, then the comparison 786 indicates that the user interface of the underlying software application(s) has changed.

Optionally, the fingerprint comparison process 700 can also perform additional processing to determine whether a notification of detected changes in the underlying software application should the provided. In this regard, the fingerprint comparison process 700 can determine 788 a change severity level. The change severity level can be dependent upon the number, type or degree of change that has been determined from the comparison 786. The comparison 786 can be performed on an element-by element-basis, such that the particular elements that changed are known as well as a number of the elements that have changed. From such information, a change severity level can be determined 788. Also, in one implementation, validation criteria can be predetermined and utilized in determining the change severity level. The validation criteria can be supplied with the software robot to be executed. The validation criteria can also be configurable such that it can be set when the software robot is created or alternatively able to be configured whenever executed.

Following the determination 788 of the change severity level, a decision 790 can determine whether notification is needed. The decision 790 can determine whether notification is needed based on the change severity level. When the decision 790 determines that notification is needed, a notification can be provided 792 to the user. Alternatively, when the decision 790 determines that a notification is not needed, then the fingerprint comparison process 700 can and without providing a notification. Following the block 792, or following the decision 790 when no notification is provided, the fingerprint comparison process 700 can and.

It should be noted that FIG. 7D can evaluate severity of one or more detected changes as determined from comparison of fingerprints. The severity can be quantified into a level of severity, and the severity (or level of severity) can trigger a notification. For example, if the detected change is deemed minor, a notification might not be provided. On the other hand, if the detected change is serious and likely to cause a software robot to fail, then a notification is probably warranted. The seriousness of the detected changes depends on the underlying software application usage involving the change. For example, those changes deemed serious can include an existing object that is being automated but is no longer present (e.g., the software robot seeks an object “Phone number” which is no longer present in the application's user interface). An example of a change that is deemed minor can include an additional field to an application's user interface that is not mandatory (e.g., an “Extension” field was added to the “Phone number” field but it is not a required field, so the software robot need not interact with the added field).

In one embodiment, an RPA system can configure the condition when notifications are to be provided. For example, a Validation Criteria Configuration (VCC) can be provided by an RPA system, such that the criteria can be used to classify detected changes to elements, such as changes to specific properties of elements, as high, medium or low severity. For instance, if a change to a property “HTML ID” is detected and that property is considered as high severity, then a user should be notified of a need to update or change a software robot.

As noted, the fingerprint comparison process 700 can be carried out during execution of a software robot. It should be understood that some of the terminology in FIG. 7C may pertain to HTML-type user interfaces, and that other types of application programs may use different terminology to reference its user interfaces but nevertheless operate in generally the same manner.

Some examples of fingerprints used in detecting changes to an application program are provided below and described with reference to FIGS. 7E-7H.

FIG. 7E illustrates an exemplary user interface screen 795 that has been produced by an underlying application program during creation of a software robot (e.g., bot). In this example, the underlying application program is a static web application and the exemplary user interface screen 795 being produced is seeking to validate a user based on validation criteria acquired via the exemplary user interface screen. In accordance with the above process, during creation of the software robot, a fingerprint for the exemplary user interface screen 795 can be determined and stored.

An exemplary fingerprint for the exemplary user interface screen 795 is as follows:

Fingerprint:

| | |
|---|---|
| ● | { |
| ● | “dataType”: “Map”, |
| ● | “value”: [ |
| ● | [ |
| ● | |
| | “/html/body/form[1]/table[1]/tbody[1]/tr[2]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[2]/td[2]/input[1]\”],[\“HTM |
| | L Tag\”,\“INPUT\”],[\“HTML ID\”,\“txtpara1\”],[\“HTML |
| | Type\”,\“text\”],[\“HTML Name\”,\“\”],[\“HTML |
| | FrameSrc\”,\“http://ec2-34-217-153-232.us-west- |
| | 2.compute.amazonaws.com:8062/home.html\”]]}” |
| ● | ], |
| ● | [ |
| ● | |
| | “/html/body/form[1]/table[1]/tbody[1]/tr[3]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[3]/td[2]/input[1]\”],[\“HTM |
| | L Tag\”,\“INPUT\”],[\“HTML ID\”,\“txtpara2\”],[\“HTML |
| | Type\”,\“text\”],[\“HTML Name\”,\“\”],[\“HTML |
| | FrameSrc\”,\“http://ec2-34-217-153-232.us-west- |
| | 2.compute.amazonaws.com:8062/home.html\”]]}” |
| ● | ], |
| ● | [ |
| ● | |
| | “/html/body/form[1]/table[1]/tbody[1]/tr[4]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[4]/td[2]/input[1]\”],[\“HTM |
| | L Tag\”,\“INPUT\”],[\“HTML ID\”,\“\”],[\“HTML |
| | Type\”,\“number\”],[\“HTML Name\”,\“\”],[\“HTML |
| | FrameSrc\”,\“http://ec2-34-217-153-232.us-west- |
| | 2.compute.amazonaws.com:8062/home.html\”]]}” |
| ● | ], |
| ● | [ |
| ● | “//input[@id=‘txtresult’]”, |
| ● | |
| | “{\“dataType\”:\“Map\”,\“value\”:[[\“DOMXPath\”,\“//input[ |
| | @id=‘txtresult’]\”],[\“HTML Tag\”,\“INPUT\”],[\“HTML |
| | ID\”,\“txtresult\”],[\“HTML Type\”,\“text\”],[\“HTML |
| | Name\”,\“\”],[\“HTML FrameSrc\”,\“http://ec2-34-217-153- |
| | 232.us-west-2.compute.amazonaws.com:8062/home.html\”]]}” |
| ● | ], |
| ● | [ |
| ● | |
| | “/html/body/form[1]/table[1]/tbody[1]/tr[6]/td[2]/div[1]/s |
| | elect[1]”, |
| ● | |
| | “{\“dataType\”:\“Map\”,\“value\”:[[\“DOMXPath\”,\“/html/bo |
| | dy/form[1]/table[1]/tbody[1]/tr[6]/td[2]/div[1]/select[1]\” |
| | ],[\“HTML Tag\”,\“SELECT\”],[\“HTML |
| | ID\”,\“inputGroupSelect02\”],[\“HTML Type\”,\“select- |
| | one\”],[\“HTML Name\”,\“\”],[\“HTML |
| | FrameSrc\”,\“http://ec2-34-217-153-232.us-west- |
| | 2.compute.amazonaws.com:8062/home.html\”]]}” |
| ● | ], |
| ● | [ |
| ● | |
| | “/html/body/form[1]/table[1]/tbody[1]/tr[7]/td[2]/div[1]/i |
| | nput[1]”, |
| ● | |
| | “{\“dataType\”:\“Map\”,\“value\”:[[\“DOMXPath\”,\“/html/bo |
| | dy/form[1]/table[1]/tbody[1]/tr[7]/td[2]/div[1]/input[1]\”] |
| | ,[\“HTML Tag\”,\“INPUT\”],[\“HTML |
| | ID\”,\“defaultCheck1\”],[\“HTML |
| | Type\”,\“checkbox\”],[\“HTML Name\”,\“\”],[\“HTML |
| | FrameSrc\”,\“http://ec2-34-217-153-232.us-west- |
| | 2.compute.amazonaws.com:8062/home.html\”]]}” |
| ● | ], |
| ● | [ |
| ● | “//button[@id=‘btnConcat’]”, |
| ● | |
| | “{\“dataType\”:\“Map\”,\“value\”:[[\“DOMXPath\”,\“//button |
| | [@id=‘btnConcat’]\”],[\“HTML Tag\”,\“BUTTON\”],[\“HTML |
| | ID\”,\“btnConcat\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/home.html\”]]}” |
| ● | ], |
| ● | [ |
| ● | “//button[@id=‘btnSplit’]”, |
| ● | |
| | “{\“dataType\”:\“Map\”,\“value\”:[[\“DOMXPath\”,\“//button |
| | [@id=‘btnSplit’]\”],[\“HTML Tag\”,\“BUTTON\”],[\“HTML |
| | ID\”,\“btnSplit\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/home.html\”]]}” |
| ● | ], |
| ● | [ |
| ● | “//button[@id=‘btnSuccess']”, |
| ● | |
| | “{\“dataType\”:\“Map\”,\“value\”:[[\“DOMXPath\”,\“//button |
| | [@id=‘btnSuccess']\”],[\“HTML Tag\”,\“BUTTON\”],[\“HTML |
| | ID\”,\“btnSuccess\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/home.html\”]]}” |
| ● | ], |
| ● | [ |
| ● | “//button[@id=‘btnDanger’]”, |
| ● | |
| | “{\“dataType\”:\“Map\”,\“value\”:[[\“DOMXPath\”,\“//button |
| | [@id=‘btnDanger’]\”],[\“HTML Tag\”,\“BUTTON\”],[\“HTML |
| | ID\”,\“btnDanger\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/home.html\”]]}” |
| ● | ], |
| ● | [ |
| ● | “//button[@id=‘btnWarning’]”, |
| ● | |
| | “{\“dataType\”:\“Map\”,\“value\”:[[\“DOMXPath\”,\“//button |
| | [@id=‘btnWarning’]\”],[\“HTML Tag\”,\“BUTTON\”],[\“HTML |
| | ID\”,\“btnWarning\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/home.html\”]]}” |
| ● | ] |
| ● | ] |
| | } |

] FIG. 7F illustrates an exemplary user interface screen 796 that has been produced by an underlying application program execution of a previously created software robot (e.g., bot).

In this example, the underlying application program is a static web application and the exemplary user interface screen 796 being produced is seeking to validate a user based on validation criteria acquired via the exemplary user interface screen. In accordance with the above process, during execution of the software robot, a fingerprint for the exemplary user interface screen 796 can be determined.

An exemplary fingerprint for the exemplary user interface screen 796 is as follows:

| Fingerprint: | |
|---|---|
| ● | { |
| ● | “dataType”: “Map”, |
| ● | “value”: [ |
| ● | [ |
| ● | |
| | “/html/body/form[1]/table[1]/tbody[1]/tr[2]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[2]/td[2]/input[1]\”],[\“HTM |
| | L Tag\”,\“INPUT\”],[\“HTML ID\”,\“txtpara1\”],[\“HTML |
| | Type\”,\“text\”],[\“HTML Name\”,\“\”],[\“HTML |
| | FrameSrc\”,\“http://ec2-34-217-153-232.us-west- |
| | 2.compute.amazonaws.com:8062/missing-elements.html\”]]}” |
| ● | ], |
| ● | [ |
| ● | |
| | “/html/body/form[1]/table[1]/tbody[1]/tr[3]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[3]/td[2]/input[1]\”],[\“HTM |
| | L Tag\”,\“INPUT\”],[\“HTML ID\”,\“txtpara2\”],[\“HTML |
| | Type\”,\“text\”],[\“HTML Name\”,\“\”],[\“HTML |
| | FrameSrc\”,\“http://ec2-34-217-153-232.us-west- |
| | 2.compute.amazonaws.com:8062/missing-elements.html\”]]}” |
| ● | ], |
| ● | [ |
| ● | |
| | “/html/body/form[1]/table[1]/tbody[1]/tr[4]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[4]/td[2]/input[1]\”],[\“HTM |
| | L Tag\”,\“INPUT\”],[\“HTML ID\”,\“\”],[\“HTML |
| | Type\”,\“number\”],[\“HTML Name\”,\“\”],[\“HTML |
| | FrameSrc\”,\“http://ec2-34-217-153-232.us-west- |
| | 2.compute.amazonaws.com:8062/missing-elements.html\”]]}” |
| ● | ], |
| ● | [ |
| ● | “//input[@id=‘txtresult’]”, |
| ● | |
| | “{\“dataType\”:\“Map\”,\“value\”:[[\“DOMXPath\”,\“//input[ |
| | @id=‘txtresult’]\”],[\“HTML Tag\”,\“INPUT\”],[\“HTML |
| | ID\”,\“txtresult\”],[\“HTML Type\”,\“text\”],[\“HTML |
| | Name\”,\“\”],[\“HTML FrameSrc\”,\“http://ec2-34-217-153- |
| | 232.us-west-2.compute.amazonaws.com:8062/missing- |
| | elements.html\”]]}” |
| ● | ], |
| ● | [ |
| ● | |
| | “/html/body/form[1]/table[1]/tbody[1]/tr[6]/td[2]/div[1]/s |
| | elect[1]”, |
| ● | |
| | “{\“dataType\”:\“Map\”,\“value\”:[[\“DOMXPath\”,\“/html/bo |
| | dy/form[1]/table[1]/tbody[1]/tr[6]/td[2]/div[1]/select[1]\” |
| | ],[\“HTML Tag\”,\“SELECT\”],[\“HTML |
| | ID\”,\“inputGroupSelect02\”],[\“HTML Type\”,\“select- |
| | one\”],[\“HTML Name\”,\“\”],[\“HTML |
| | FrameSrc\”,\“http://ec2-34-217-153-232.us-west- |
| | 2.compute.amazonaws.com:8062/missing-elements.html\”]]}” |
| ● | ], |
| ● | [ |
| ● | |
| | “/html/body/form[1]/table[1]/tbody[1]/tr[7]/td[2]/div[1]/i |
| | nput[1]”, |
| ● | |
| | “{\“dataType\”:\“Map\”,\“value\”:[[\“DOMXPath\”,\“/html/bo |
| | dy/form[1]/table[1]/tbody[1]/tr[7]/td[2]/div[1]/input[1]\”] |
| | ,[\“HTML Tag\”,\“INPUT\”],[\“HTML |
| | ID\”,\“defaultCheck1\”],[\“HTML |
| | Type\”,\“checkbox\”],[\“HTML Name\”,\“\”],[\“HTML |
| | FrameSrc\”,\“http://ec2-34-217-153-232.us-west- |
| | 2.compute.amazonaws.com:8062/missing-elements.html\”]]}” |
| ● | ], |
| ● | [ |
| ● | “//button[@id=‘btnConcat’]”, |
| ● | |
| | “{\“dataType\”:\“Map\”,\“value\”:[[\“DOMXPath\”,\“//button |
| | [@id=‘btnConcat’]\”],[\“HTML Tag\”,\“BUTTON\”],[\“HTML |
| | ID\”,\“btnConcat\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/missing- |
| | elements.html\”]]}” |
| ● | ], |
| ● | [ |
| ● | “//button[@id=‘btnSplit’]”, |
| ● | |
| | “{\“dataType\”:\“Map\”,\“value\”:[[\“DOMXPath\”,\“//button |
| | [@id=‘btnSplit’]\”],[\“HTML Tag\”,\“BUTTON\”],[\“HTML |
| | ID\”,\“btnSplit\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/missing- |
| | elements.html\”]]}” |
| ● | ], |
| ● | [ |
| ● | “//button[@id=‘btnSuccess']”, |
| ● | |
| | “{\“dataType\”:\“Map\”,\“value\”:[[\“DOMXPath\”,\“//button |
| | [@id=‘btnSuccess']\”],[\“HTML Tag\”,\“BUTTON\”],[\“HTML |
| | ID\”,\“btnSuccess\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/missing- |
| | elements.html\”]]}” |
| ● | ], |
| ● | [ |
| ● | “//button[@id=‘btnDanger’]”, |
| ● | |
| | “{\“dataType\”:\“Map\”,\“value\”:[[\“DOMXPath\”,\“//button |
| | [@id=‘btnDanger’]\”],[\“HTML Tag\”,\“BUTTON\”],[\“HTML |
| | ID\”,\“btnDanger\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/missing- |
| | elements.html\”]]}” |
| ● | ] |
| ● | ] |
| | } |
| ● | Delta: |
| ● | Missing element //button[@id=‘btnWarning’] |
| | Element attributes |
| | {“dataType”:“Map”,“value”:[[“DOMXPath”,“//button[@id=‘btnWa |
| | rning’]”],[“HTML Tag”,“BUTTON”],[“HTML |
| | ID”,“btnWarning”],[“HTML Type”,“button”],[“HTML |
| | Name”,“”],[“HTML FrameSrc”,“http://ec2-34-217-153-232.us- |
| | west-2.compute.amazonaws.com:8062/home.html”]]} |

The determined fingerprint for the exemplary user interface screen 796 can then compared with the exemplary fingerprint previously determined for the exemplary user interface screen 795. In this example, the exemplary user interface screen 796 shown in FIG. 7F has an element (e.g., “warning” button) removed as compared to the exemplary user interface screen 795 shown in FIG. 7E. This change can be detected by comparing the respective fingerprints. As noted in the Delta noted above, the comparing of the respective fingerprints indicated that the “warning” button is an element missing from the exemplary user interface screen 796. In one embodiment, the exemplary user interface screen 796 (or another user interface) can distinctively display an indication of where the missing “warning” button was previously located.

FIG. 7G illustrates an exemplary user interface screen 797 that has been produced by an underlying application program execution of a previously created software robot (e.g., bot).

In this example, the underlying application program is a static web application and the exemplary user interface screen 797 being produced is seeking to validate a user based on validation criteria acquired via the exemplary user interface screen. In accordance with the above process, during execution of the software robot, a fingerprint for the exemplary user interface screen 797 can be determined.

An exemplary fingerprint for the exemplary user interface screen 797 is as follows:

| Fingerprint: | |
|---|---|
| ● | { |
| ● | “dataType”: “Map”, |
| ● | “value”: [ |
| ● | [ |
| ● | |
| | “/html/body/form[1]/table[1]/tbody[1]/tr[2]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[2]/td[2]/input[1]\”],[\“HTM |
| | L Tag\”,\“INPUT\”],[\“HTML ID\”,\“txtpara1\”],[\“HTML |
| | Type\”,\“text\”],[\“HTML Name\”,\“\”],[\“HTML |
| | FrameSrc\”,\“http://ec2-34-217-153-232.us-west- |
| | 2.compute.amazonaws.com:8062/new-elements.html\”]]}” |
| ● | ], |
| ● | [ |
| ● | |
| | “/html/body/form[1]/table[1]/tbody[1]/tr[3]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[3]/td[2]/input[1]\”],[\“HTM |
| | L Tag\”,\“INPUT\”],[\“HTML ID\”,\“txtpara2\”],[\“HTML |
| | Type\”,\“text\”],[\“HTML Name\”,\“\”],[\“HTML |
| | FrameSrc\”,\“http://ec2-34-217-153-232.us-west- |
| | 2.compute.amazonaws.com:8062/new-elements.html\”]]}” |
| ● | ], |
| ● | [ |
| ● | |
| | “/html/body/form[1]/table[1]/tbody[1]/tr[4]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[4]/td[2]/input[1]\”],[\“HTM |
| | L Tag\”,\“INPUT\”],[\“HTML ID\”,\“\”],[\“HTML |
| | Type\”,\“number\”],[\“HTML Name\”,\“\”],[\“HTML |
| | FrameSrc\”,\“http://ec2-34-217-153-232.us-west- |
| | 2.compute.amazonaws.com:8062/new-elements.html\”]]}” |
| ● | ], |
| ● | [ |
| ● | “//input[@id=‘txtresult’]”, |
| ● | |
| | “{\“dataType\”:\“Map\”,\“value\”:[[\“DOMXPath\”,\“//input[ |
| | @id=‘txtresult’]\”],[\“HTML Tag\”,\“INPUT\”],[\“HTML |
| | ID\”,\“txtresult\”],[\“HTML Type\”,\“text\”],[\“HTML |
| | Name\”,\“\”],[\“HTML FrameSrc\”,\“http://ec2-34-217-153- |
| | 232.us-west-2.compute.amazonaws.com:8062/new- |
| | elements.html\”]]}” |
| ● | ], |
| ● | [ |
| ● | |
| | “/html/body/form[1]/table[1]/tbody[1]/tr[6]/td[2]/div[1]/s |
| | elect[1]”, |
| ● | |
| | “{\“dataType\”:\“Map\”,\“value\”:[[\“DOMXPath\”,\“/html/bo |
| | dy/form[1]/table[1]/tbody[1]/tr[6]/td[2]/div[1]/select[1]\” |
| | ],[\“HTML Tag\”,\“SELECT\”],[\“HTML |
| | ID\”,\“inputGroupSelect02\”],[\“HTML Type\”,\“select- |
| | one\”],[\“HTML Name\”,\“\”],[\“HTML |
| | FrameSrc\”,\“http://ec2-34-217-153-232.us-west- |
| | 2.compute.amazonaws.com:8062/new-elements.html\”]]}” |
| ● | ], |
| ● | [ |
| ● | |
| | “/html/body/form[1]/table[1]/tbody[1]/tr[7]/td[2]/div[1]/i |
| | nput[1]”, |
| ● | |
| | “{\“dataType\”:\“Map\”,\“value\”:[[\“DOMXPath\”,\“/html/bo |
| | dy/form[1]/table[1]/tbody[1]/tr[7]/td[2]/div[1]/input[1]\”] |
| | ,[\“HTML Tag\”,\“INPUT\”],[\“HTML |
| | ID\”,\“defaultCheck1\”],[\“HTML |
| | Type\”,\“checkbox\”],[\“HTML Name\”,\“\”],[\“HTML |
| | FrameSrc\”,\“http://ec2-34-217-153-232.us-west- |
| | 2.compute.amazonaws.com:8062/new-elements.html\”]]}” |
| ● | ], |
| ● | [ |
| ● | “//button[@id=‘btnConcat’]”, |
| ● | |
| | “{\“dataType\”:\“Map\”,\“value\”:[[\“DOMXPath\”,\“//button |
| | [@id=‘btnConcat’]\”],[\“HTML Tag\”,\“BUTTON\”],[\“HTML |
| | ID\”,\“btnConcat\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/new- |
| | elements.html\”]]}” |
| ● | ], |
| ● | [ |
| ● | “//button[@id=‘btnSplit’]”, |
| ● | |
| | “{\“dataType\”:\“Map\”,\“value\”:[[\“DOMXPath\”,\“//button |
| | [@id=‘btnSplit’]\”],[\“HTML Tag\”,\“BUTTON\”],[\“HTML |
| | ID\”,\“btnSplit\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/new- |
| | elements.html\”]]}” |
| ● | ], |
| ● | [ |
| ● | “//button[@id=‘btnSuccess']”, |
| ● | |
| | “{\“dataType\”:\“Map\”,\“value\”:[[\“DOMXPath\”,\“//button |
| | [@id=‘btnSuccess']\”],[\“HTML Tag\”,\“BUTTON\”],[\“HTML |
| | ID\”,\“btnSuccess\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/new- |
| | elements.html\”]]}” |
| ● | ], |
| ● | [ |
| ● | “//button[@id=‘btnDanger’]”, |
| ● | |
| | “{\“dataType\”:\“Map\”,\“value\”:[[\“DOMXPath\”,\“//button |
| | [@id=‘btnDanger’]\”],[\“HTML Tag\”,\“BUTTON\”],[\“HTML |
| | ID\”,\“btnDanger\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/new- |
| | elements.html\”]]}” |
| ● | ], |
| ● | [ |
| ● | “//button[@id=‘btnWarning’]”, |
| ● | |
| | “{\“dataType\”:\“Map\”,\“value\”:[[\“DOMXPath\”,\“//button |
| | [@id=‘btnWarning’]\”],[\“HTML Tag\”,\“BUTTON\”],[\“HTML |
| | ID\”,\“btnWarning\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/new- |
| | elements.html\”]]}” |
| ● | ], |
| ● | [ |
| ● | “//button[@id=‘btnInfo’]”, |
| ● | |
| | “{\“dataType\”:\“Map\”,\“value\”:[[\“DOMXPath\”,\“//button |
| | [@id=‘btnInfo’]\”],[\“HTML Tag\”,\“BUTTON\”],[\“HTML |
| | ID\”,\“btnInfo\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/new- |
| | elements.html\”]]}” |
| ● | ] |
| ● | ] |
| | } |
| ● | Delta: |
| ● | New element //button[@id=‘btnSave’] |
| | Element attributes |
| | {“dataType”:“Map”,“value”:[[“DOMXPath”,“//button[@id=‘btnSa |
| | ve’]”],[“HTML Tag”,“BUTTON”],[“HTML ID”,“btnSave”],[“HTML |
| | Type”,“button”],[“HTML Name”,“”],[“HTML |
| | FrameSrc”,“http://ec2-34-217-153-232.us-west- |
| | 2.compute.amazonaws.com:8062/new-elements.html”]]} |

The determined fingerprint for the exemplary user interface screen 797 can then compared with the exemplary fingerprint previously determined for the exemplary user interface screen 795. In this example, the exemplary user interface screen 797 shown in FIG. 7G has an element (e.g., “save” button) added as compared to the exemplary user interface screen 795 shown in FIG. 7E. This change can be detected by comparing the respective fingerprints. As noted in the Delta noted above, the comparing of the respective fingerprints indicated that the “save” button is a new element added to the exemplary user interface screen 797. In one embodiment, the exemplary user interface screen 797 (or another user interface) can distinctively display an indication of where the newly added “save” button is located.

FIG. 7H illustrates an exemplary user interface screen 798 that has been produced by an underlying application program execution of a previously created software robot (e.g., bot).

In this example, the underlying application program is a static web application and the exemplary user interface screen 798 being produced is seeking to validate a user based on validation criteria acquired via the exemplary user interface screen. In accordance with the above process, during execution of the software robot, a fingerprint for the exemplary user interface screen 798 can be determined.

An exemplary fingerprint for the exemplary user interface screen 798 is as follows:

Fingerprint:

| | |
|---|---|
| ● | { |
| ● | “dataType”: “Map”, |
| ● | “value”: [ |
| ● | [ |
| ● | |
| | “/html/body/form[1]/table[1]/tbody[1]/tr[2]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[2]/td[2]/input[1]\”],[\“HTM |
| | L Tag\”,\“INPUT\”],[\“HTML ID\”,\“txtpara1\”],[\“HTML |
| | Type\”,\“text\”],[\“HTML Name\”,\“\”],[\“HTML |
| | FrameSrc\”,\“http://ec2-34-217-153-232.us-west- |
| | 2.compute.amazonaws.com:8062/element-change.html\”]]}” |
| ● | ], |
| ● | [ |
| ● | |
| | “/html/body/form[1]/table[1]/tbody[1]/tr[3]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[3]/td[2]/input[1]\”],[\“HTM |
| | L Tag\”,\“INPUT\”],[\“HTML ID\”,\“txtpara2\”],[\“HTML |
| | Type\”,\“text\”],[\“HTML Name\”,\“\”],[\“HTML |
| | FrameSrc\”,\“http://ec2-34-217-153-232.us-west- |
| | 2.compute.amazonaws.com:8062/element-change.html\”]]}” |
| ● | ], |
| ● | [ |
| ● | |
| | “/html/body/form[1]/table[1]/tbody[1]/tr[4]/td[2]/input[1] |
| | ”, |
| ● | |
| | “{\“dataType\”:\“Map\”,\“value\”:[[\“DOMXPath\”,\“/html/bo |
| | dy/form[1]/table[1]/tbody[1]/tr[4]/td[2]/input[1]\”],[\“HTM |
| | L Tag\”,\“INPUT\”],[\“HTML ID\”,\“\”],[\“HTML |
| | Type\”,\“number\”],[\“HTML Name\”,\“\”],[\“HTML |
| | FrameSrc\”,\“http://ec2-34-217-153-232.us-west- |
| | 2.compute.amazonaws.com:8062/element-change.html\”]]}” |
| ● | [, |
| ● | [ |
| ● | “//input[@id=‘txtresult’]”, |
| ● | |
| | “{\“dataType\”:\“Map\”,\“value\”:[[\“DOMXPath\”,\“//input[ |
| | @id=‘txtresult’]\”],[\“HTML Tag\”,\“INPUT\”],[\“HTML |
| | ID\”,\“txtresult\”],[\“HTML Type\”,\“text\”],[\“HTML |
| | Name\”,\“\”],[\“HTML FrameSrc\”,\“http://ec2-34-217-153- |
| | 232.us-west-2.compute.amazonaws.com:8062/element- |
| | change.html\”]]}” |
| ● | ], |
| ● | [ |
| ● | |
| | “/html/body/form[1]/table[1]/tbody[1]/tr[6]/td[2]/div[1]/s |
| | elect[1]”, |
| ● | |
| | “{\“dataType\”:\“Map\”,\“value\”:[[\“DOMXPath\”,\“/html/bo |
| | dy/form[1]/table[1]/tbody[1]/tr[6]/td[2]/div[1]/select[1]\” |
| | ],[\“HTML Tag\”,\“SELECT\”],[\“HTML |
| | ID\”,\“inputGroupSelect02\”],[\“HTML Type\”,\“select- |
| | one\”],[\“HTML Name\”,\“\”],[\“HTML |
| | FrameSrc\”,\“http://ec2-34-217-153-232.us-west- |
| | 2.compute.amazonaws.com:8062/element-change.html\”]]}” |
| ● | ], |
| ● | [ |
| ● | |
| | “/html/body/form[1]/table[1]/tbody[1]/tr[7]/td[2]/div[1]/i |
| | nput[1]”, |
| ● | |
| | “{\“dataType\”:\“Map\”,\“value\”:[[\“DOMXPath\”,\“/html/bo |
| | dy/form[1]/table[1]/tbody[1]/tr[7]/td[2]/div[1]/input[1]\”] |
| | ,[\“HTML Tag\”,\“INPUT\”],[\“HTML |
| | ID\”,\“defaultCheck1\”],[\“HTML |
| | Type\”,\“checkbox\”],[\“HTML Name\”,\“\”],[\“HTML |
| | FrameSrc\”,\“http://ec2-34-217-153-232.us-west- |
| | 2.compute.amazonaws.com:8062/element-change.html\”]]}” |
| ● | ], |
| ● | [ |
| ● | “//button[@id=‘btnConcat’]”, |
| ● | |
| | “{\“dataType\”:\“Map\”,\“value\”:[[\“DOMXPath\”,\“//button |
| | [@id=‘btnConcat’]\”],[\“HTML Tag\”,\“BUTTON\”],[\“HTML |
| | ID\”,\“btnConcat\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/element- |
| | change.html\”]]}” |
| ● | ], |
| ● | [ |
| ● | “//button[@id=‘btnSplit’]”, |
| ● | |
| | “{\“dataType\”:\“Map\”,\“value\”:[[\“DOMXPath\”,\“//button |
| | [@id=‘btnSplit’]\”],[\“HTML Tag\”,\“BUTTON\”],[\“HTML |
| | ID\”,\“btnSplit\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/element- |
| | change.html\”]]}” |
| ● | ], |
| ● | [ |
| ● | “//button[@id=‘btnSuccess']”, |
| ● | |
| | “{\“dataType\”:\“Map\”,\“value\”:[[\“DOMXPath\”,\“//button |
| | [@id=‘btnSuccess']\”],[\“HTML Tag\”,\“BUTTON\”],[\“HTML |
| | ID\”,\“btnSuccess\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/element- |
| | change.html\”]]}” |
| ● | ], |
| ● | [ |
| ● | “//button[@id=‘btnDanger’]”, |
| ● | |
| | “{\“dataType\”:\“Map\”,\“value\”:[[\“DOMXPath\”,\“//button |
| | [@id=‘btnDanger’]\”],[\“HTML Tag\”,\“BUTTON\”],[\“HTML |
| | ID\”,\“btnDanger\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/element- |
| | change.html\”]]}” |
| ● | ], |
| ● | [ |
| ● | “//button[@id=‘btnInfo’]”, |
| ● | |
| | “{\“dataType\”:\“Map\”,\“value\”:[[\“DOMXPath\”,\“//button |
| | [@id=‘btnInfo’]\”],[\“HTML Tag\”,\“BUTTON\”],[\“HTML |
| | ID\”,\“btnInfo\”],[\“HTML Type\”,\“button\”],[\“HTML |
| | Name\”,\“\”],[\“HTML FrameSrc\”,\“http://ec2-34-217-153- |
| | 232.us-west-2.compute.amazonaws.com:8062/element- |
| | change.html\”]]}” |
| ● | ] |
| ● | ] |
| | } |
| ● | Delta: |
| ● | Missing element //button[@id=‘btnWarning’] |
| ● | Element attributes |
| | {“dataType”:“Map”,“value”:[[“DOMXPath”,“//button[@id=‘btnWa |
| | rning’]”],[“HTML Tag”,“BUTTON”],[“HTML |
| | ID”,“btnWarning”],[“HTML Type”,“button”],[“HTML |
| | Name”,“”],[“HTML FrameSrc”,“http://ec2-34-217-153-232.us- |
| | west-2.compute.amazonaws.com:8062/home.html”]]} |
| ● | |
| ● | New element //button[@id=‘btnSave’] |
| | Element attributes |
| | {“dataType”:“Map”,“value”:[[“DOMXPath”,“//button[@id=‘btnIS |
| | ave’]”],[“HTML Tag”,“BUTTON”],[“HTML ID”,“btnSave”],[“HTML |
| | Type”,“button”],[“HTML Name”,“”],[“HTML |
| | FrameSrc”,“http://ec2-34-217-153-232.us-west- |
| | 2.compute.amazonaws.com:8062/element-change.html”]]} |

The determined fingerprint for the exemplary user interface screen 798 can then compared with the exemplary fingerprint previously determined for the exemplary user interface screen 795. In this example, the exemplary user interface screen 798 shown in FIG. 7H has (i) an element (e.g., “warning” button) removed and (ii) an element (e.g., “save” button) added, as compared to the exemplary user interface screen 795 shown in FIG. 7E. These changes can be detected by comparing the respective fingerprints. As noted in the Delta noted above, the comparing of the respective fingerprints indicated that the “warning” button is an element missing from the exemplary user interface screen 798 and that the “save” button is a newly added element to the exemplary user interface screen 798. In one embodiment, the exemplary user interface screen 798 (or another user interface) can distinctively display an indication of where the missing “warning” button was previously located, and an indication of where the newly added “save” button is located.

The various aspects disclosed herein can be utilized with or by robotic process automation systems. Exemplary robotic process automation systems and operations thereof are detailed below.

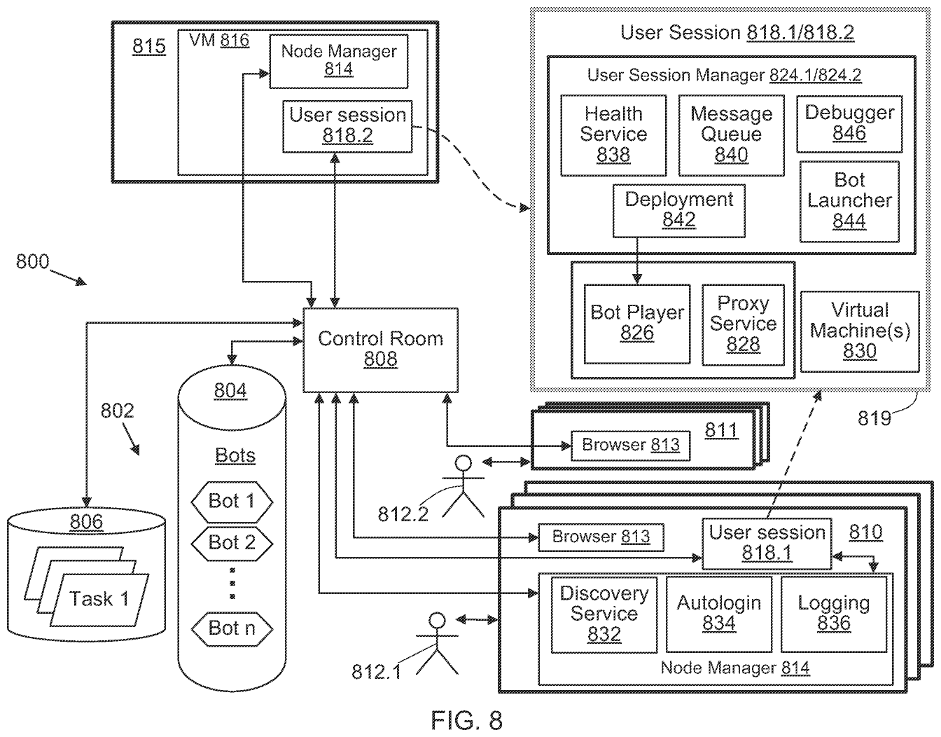

FIG. 8 is a block diagram of a robotic process automation (RPA) system 800 according to one embodiment. The RPA system 800 includes data storage 802. The data storage 802 can store a plurality of software robots 804, also referred to as bots (e.g., Bot 1, Bot 2, . . . , Bot n). The software robots 804 can be operable to interact at a user level with one or more user level application programs (not shown). As used herein, the term “bot” is generally synonymous with the term software robot. In certain contexts, as will be apparent to those skilled in the art in view of the present disclosure, the term “bot runner” refers to a device (virtual or physical), having the necessary software capability (such as bot player 826), on which a bot will execute or is executing. The data storage 802 can also stores a plurality of work items 806. Each work item 806 can pertain to processing executed by one or more of the software robots 804.

The RPA system 800 can also include a control room 808. The control room 808 is operatively coupled to the data storage 802 and is configured to execute instructions that, when executed, cause the RPA system 800 to respond to a request from a client device 810 that is issued by a user 812.1. The control room 808 can act as a server to provide to the client device 810 the capability to perform an automation task to process a work item from the plurality of work items 806. The RPA system 800 is able to support multiple client devices 810 concurrently, each of which will have one or more corresponding user session(s) 818, which provides a context. The context can, for example, include security, permissions, audit trails, etc. to define the permissions and roles for bots operating under the user session 818. For example, a bot executing under a user session, cannot access any files or use any applications that the user, under whose credentials the bot is operating, does not have permission to do so. This prevents any inadvertent or malicious acts from a bot under which bot 804 executes.

The control room 808 can provide, to the client device 810, software code to implement a node manager 814. The node manager 814 executes on the client device 810 and provides a user 812 a visual interface via browser 813 to view progress of and to control execution of automation tasks. It should be noted that the node manager 814 can be provided to the client device 810 on demand, when required by the client device 810, to execute a desired automation task. In one embodiment, the node manager 814 may remain on the client device 810 after completion of the requested automation task to avoid the need to download it again. In another embodiment, the node manager 814 may be deleted from the client device 810 after completion of the requested automation task. The node manager 814 can also maintain a connection to the control room 808 to inform the control room 808 that device 810 is available for service by the control room 808, irrespective of whether a live user session 818 exists. When executing a bot 804, the node manager 814 can impersonate the user 812 by employing credentials associated with the user 812.

The control room 808 initiates, on the client device 810, a user session 818 (seen as a specific instantiation 818.1) to perform the automation task. The control room 808 retrieves the set of task processing instructions 804 that correspond to the work item 806. The task processing instructions 804 that correspond to the work item 806 can execute under control of the user session 818.1, on the client device 810. The node manager 814 can provide update data indicative of status of processing of the work item to the control room 808. The control room 808 can terminate the user session 818.1 upon completion of processing of the work item 806. The user session 818.1 is shown in further detail at 819, where an instance 824.1 of user session manager 824 is seen along with a bot player 826, proxy service 828, and one or more virtual machine(s) 830, such as a virtual machine that runs Java® or Python®. The user session manager 824 provides a generic user session context within which a bot 804 executes.

The bots 804 execute on a player, via a computing device, to perform the functions encoded by the bot. Some or all of the bots 804 may in certain embodiments be located remotely from the control room 808. Moreover, the devices 810 and 811, which may be conventional computing devices, such as for example, personal computers, server computers, laptops, tablets and other portable computing devices, may also be located remotely from the control room 808. The devices 810 and 811 may also take the form of virtual computing devices. The bots 804 and the work items 806 are shown in separate containers for purposes of illustration but they may be stored in separate or the same device(s), or across multiple devices. The control room 808 can perform user management functions, source control of the bots 804, along with providing a dashboard that provides analytics and results of the bots 804, performs license management of software required by the bots 804 and manages overall execution and management of scripts, clients, roles, credentials, security, etc. The major functions performed by the control room 808 can include: (i) a dashboard that provides a summary of registered/active users, tasks status, repository details, number of clients connected, number of scripts passed or failed recently, tasks that are scheduled to be executed and those that are in progress; (ii) user/role management -permits creation of different roles, such as bot creator, bot runner, admin, and custom roles, and activation, deactivation and modification of roles; (iii) repository management
to manage all scripts, tasks, workflows and reports etc.; (iv) operations management -permits checking status of tasks in progress and history of all tasks, and permits the administrator to stop/start execution of bots currently executing; (v) audit trail —logs creation of all actions performed in the control room; (vi) task scheduler —permits scheduling tasks which need to be executed on different clients at any particular time; (vii) credential management —permits password management; and (viii) security: management —permits rights management for all user roles. The control room 808 is shown generally for simplicity of explanation. Multiple instances of the control room 808 may be employed where large numbers of bots are deployed to provide for scalability of the RPA system 800.

In the event that a device, such as device 811 (e.g., operated by user 812.2) does not satisfy the minimum processing capability to run a node manager 814, the control room 808 can make use of another device, such as device 815, that has the requisite capability. In such case, a node manager 814 within a Virtual Machine (VM), seen as VM 816, can be resident on the device 815. The node manager 814 operating on the device 815 can communicate with browser 813 on device 811. This approach permits RPA system 800 to operate with devices that may have lower processing capability, such as older laptops, desktops, and portable/mobile devices such as tablets and mobile phones. In certain embodiments the browser 813 may take the form of a mobile application stored on the device 811. The control room 808 can establish a user session 818.2 for the user 812.2 while interacting with the control room 808 and the corresponding user session 818.2 operates as described above for user session 818.1 with user session manager 824 operating on device 810 as discussed above.

In certain embodiments, the user session manager 824 provides five functions. First is a health service 838 that maintains and provides a detailed logging of bot execution including monitoring memory and CPU usage by the bot and other parameters such as number of file handles employed. The bots 804 can employ the health service 838 as a resource to pass logging information to the control room 808. Execution of the bot is separately monitored by the user session manager 824 to track memory, CPU, and other system information. The second function provided by the user session manager 824 is a message queue 840 for exchange of data between bots executed within the same user session 818. The third function is a deployment service (also referred to as a deployment module) 842 that connects to the control room 808 to request execution of a requested bot 804. The deployment service 842 can also ensure that the environment is ready for bot execution, such as by making available dependent libraries. The fourth function is a bot launcher 844 which can read metadata associated with a requested bot 804 and launch an appropriate container and begin execution of the requested bot. The fifth function is a debugger service 846 that can be used to debug bot code.

The bot player 826 can execute, or play back, a sequence of instructions encoded in a bot. The sequence of instructions can, for example, be captured by way of a recorder when a human performs those actions, or alternatively the instructions are explicitly coded into the bot. These instructions enable the bot player 826, to perform the same actions as a human would do in their absence. In one implementation, the instructions can compose of a command (action) followed by set of parameters, for example: Open Browser is a command, and a URL would be the parameter for it to launch a web resource. Proxy service 828 can enable integration of external software or applications with the bot to provide specialized services. For example, an externally hosted artificial intelligence system could enable the bot to understand the meaning of a ‘sentence.”

The user 812.1 can interact with node manager 814 via a conventional browser 813 which employs the node manager 814 to communicate with the control room 808. When the user 812.1 logs in from the client device 810 to the control room 808 for the first time, the user 812.1 can be prompted to download and install the node manager 814 on the device 810, if one is not already present. The node manager 814 can establish a web socket connection to the user session manager 824, deployed by the control room 808 that lets the user 812.1 subsequently create, edit, and deploy the bots 804.

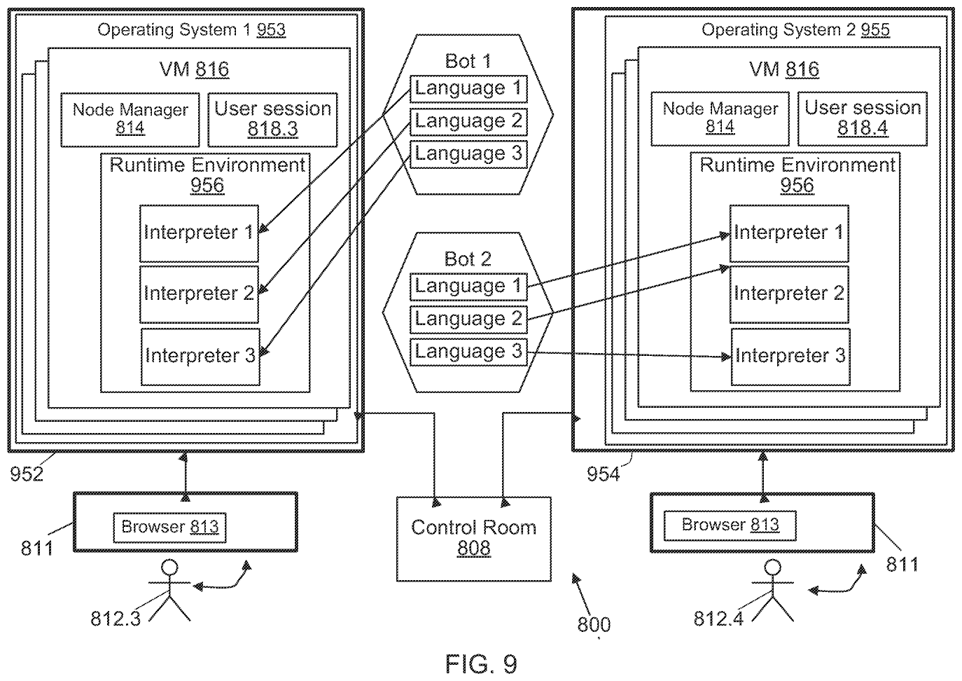

FIG. 9 is a block diagram of a generalized runtime environment for bots 804 in accordance with another embodiment of the RPA system 800 illustrated in FIG. 8. This flexible runtime environment advantageously permits extensibility of the platform to enable use of various languages in encoding bots. In the embodiment of FIG. 9, RPA system 800 generally operates in the manner described in connection with FIG. 8, except that in the embodiment of FIG. 9, some or all of the user sessions 818 execute within a virtual machine 816. This permits the bots 804 to operate on an RPA system 800 that runs on an operating system different from an operating system on which a bot 804 may have been developed. For example, if a bot 804 is developed on the Windows® operating system, the platform agnostic embodiment shown in FIG. 9 permits the bot 804 to be executed on a device 952 or 954 executing an operating system 953 or 955 different than Windows®, such as, for example, Linux. In one embodiment, the VM 816 takes the form of a Java Virtual Machine (JVM) as provided by Oracle Corporation. As will be understood by those skilled in the art in view of the present disclosure, a JVM enables a computer to run Java® programs as well as programs written in other languages that are also compiled to Java® bytecode.

In the embodiment shown in FIG. 9, multiple devices 952 can execute operating system 1, 953, which may, for example, be a Windows® operating system. Multiple devices 954 can execute operating system 2, 955, which may, for example, be a Linux® operating system. For simplicity of explanation, two different operating systems are shown, by way of example and additional operating systems such as the macOS®, or other operating systems may also be employed on devices 952, 954 or other devices. Each device 952, 954 has installed therein one or more VM's 816, each of which can execute its own operating system (not shown), which may be the same or different than the host operating system 953/955. Each VM 816 has installed, either in advance, or on demand from control room 808, a node manager 814. The embodiment illustrated in FIG. 9 differs from the embodiment shown in FIG. 8 in that the devices 952 and 954 have installed thereon one or more VMs 816 as described above, with each VM 816 having an operating system installed that may or may not be compatible with an operating system required by an automation task. Moreover, each VM has installed thereon a runtime environment 956, each of which has installed thereon one or more interpreters (shown as interpreter 1, interpreter 2, interpreter 3). Three interpreters are shown by way of example but any run time environment 956 may, at any given time, have installed thereupon less than or more than three different interpreters. Each interpreter 956 is specifically encoded to interpret instructions encoded in a particular programming language. For example, interpreter 1 may be encoded to interpret software programs encoded in the Java® programming language, seen in FIG. 9 as language 1 in Bot 1 and Bot 2. Interpreter 2 may be encoded to interpret software programs encoded in the Python® programming language, seen in FIG. 9 as language 2 in Bot 1 and Bot 2, and interpreter 3 may be encoded to interpret software programs encoded in the R programming language, seen in FIG. 9 as language 3 in Bot 1 and Bot 2.

Turning to the bots Bot 1 and Bot 2, each bot may contain instructions encoded in one or more programming languages. In the example shown in FIG. 9, each bot can contain instructions in three different programming languages, for example, Java®, Python® and R. This is for purposes of explanation and the embodiment of FIG. 9 may be able to create and execute bots encoded in more or less than three programming languages. The VMs 816 and the runtime environments 956 permit execution of bots encoded in multiple languages, thereby permitting greater flexibility in encoding bots. Moreover, the VMs 816 permit greater flexibility in bot execution. For example, a bot that is encoded with commands that are specific to an operating system, for example, open a file, or that requires an application that runs on a particular operating system, for example, Excel® on Windows®, can be deployed with much greater flexibility. In such a situation, the control room 808 will select a device with a VM 816 that has the Windows® operating system and the Excel® application installed thereon. Licensing fees can also be reduced by serially using a particular device with the required licensed operating system and application(s), instead of having multiple devices with such an operating system and applications, which may be unused for large periods of time.

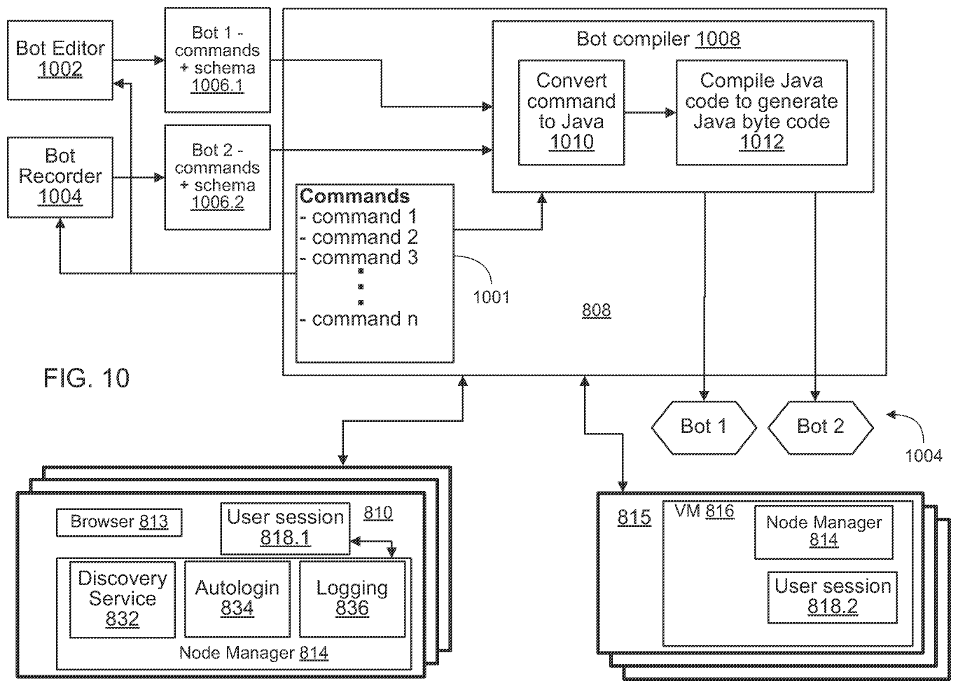

FIG. 10 illustrates a block diagram of yet another embodiment of the RPA system 800 of FIG. 8 configured to provide platform independent sets of task processing instructions for bots 804. Two bots 804, bot 1 and bot 2 are shown in FIG. 10. Each of bots 1 and 2 are formed from one or more commands 1001, each of which specifies a user level operation with a specified application program, or a user level operation provided by an operating system. Sets of commands 1006.1 and 1006.2 may be generated by bot editor 1002 and bot recorder 1004, respectively, to define sequences of application-level operations that are normally performed by a human user. The bot editor 1002 may be configured to combine sequences of commands 1001 via an editor. The bot recorder 1004 may be configured to record application-level operations performed by a user and to convert the operations performed by the user to commands 1001. The sets of commands 1006.1 and 1006.2 generated by the editor 1002 and the recorder 1004 can include command(s) and schema for the command(s), where the schema defines the format of the command(s). The format of a command can, such as, includes the input(s) expected by the command and their format. For example, a command to open a URL might include the URL, a user login, and a password to login to an application resident at the designated URL.

The control room 808 operates to compile, via compiler 1008, the sets of commands generated by the editor 1002 or the recorder 1004 into platform independent executables, each of which is also referred to herein as a bot JAR (Java ARchive) that perform application-level operations captured by the bot editor 1002 and the bot recorder 1004. In the embodiment illustrated in FIG. 10, the set of commands 1006, representing a bot file, can be captured in a JSON (JavaScript Object Notation) format which is a lightweight data-interchange text-based format. JSON is based on a subset of the JavaScript Programming Language Standard ECMA-262 3rd Edition —December 1999. JSON is built on two structures: (i) a collection of name/value pairs; in various languages, this is realized as an object, record, struct, dictionary, hash table, keyed list, or associative array, (ii) an ordered list of values which, in most languages, is realized as an array, vector, list, or sequence. Bots 1 and 2 may be executed on devices 810 and/or 815 to perform the encoded application-level operations that are normally performed by a human user.

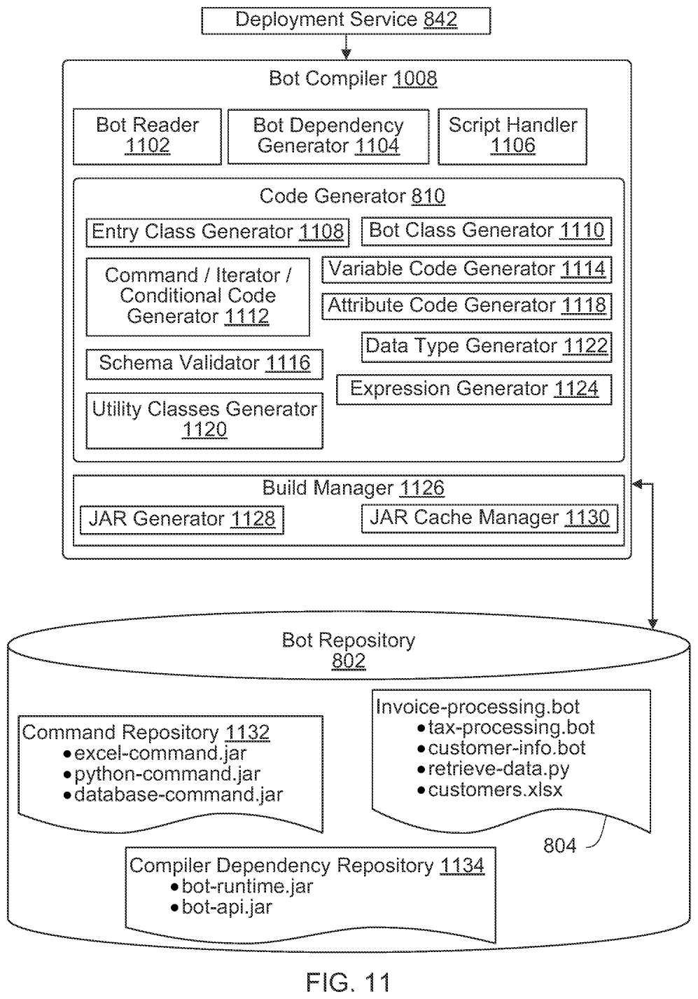

FIG. 11 is a block diagram illustrating details of one embodiment of the bot compiler 1008 illustrated in FIG. 10. The bot compiler 1008 accesses one or more of the bots 804 from the data storage 802, which can serve as bot repository, along with commands 1001 that are contained in a command repository 1132. The bot compiler 808 can also access compiler dependency repository 1134. The bot compiler 808 can operate to convert each command 1001 via code generator module 1010 to an operating system independent format, such as a Java command. The bot compiler 808 then compiles each operating system independent format command into byte code, such as Java byte code, to create a bot JAR. The convert command to Java module 1010 is shown in further detail in in FIG. 11 by JAR generator 1128 of a build manager 1126. The compiling to generate Java byte code module 1012 can be provided by the JAR generator 1128. In one embodiment, a conventional Java compiler, such as javac from Oracle Corporation, may be employed to generate the bot JAR (artifacts). As will be appreciated by those skilled in the art, an artifact in a Java environment includes compiled code along with other dependencies and resources required by the compiled code. Such dependencies can include libraries specified in the code and other artifacts. Resources can include web pages, images, descriptor files, other files, directories and archives.

As noted in connection with FIG. 10, deployment service 842 can be responsible to trigger the process of bot compilation and then once a bot has compiled successfully, to execute the resulting bot JAR on selected devices 810 and/or 815. The bot compiler 1008 can comprises a number of functional modules that, when combined, generate a bot 804 in a JAR format. A bot reader 1102 loads a bot file into memory with class representation. The bot reader 1102 takes as input a bot file and generates an in-memory bot structure. A bot dependency generator 1104 identifies and creates a dependency graph for a given bot. It includes any child bot, resource file like script, and document or image used while creating a bot. The bot dependency generator 1104 takes, as input, the output of the bot reader 1102 and provides, as output, a list of direct and transitive bot dependencies. A script handler 1106 handles script execution by injecting a contract into a user script file. The script handler 1106 registers an external script in manifest and bundles the script as a resource in an output JAR. The script handler 1106 takes, as input, the output of the bot reader 1102 and provides, as output, a list of function pointers to execute different types of identified scripts like Python, Java, VB scripts.

An entry class generator 1108 can create a Java class with an entry method, to permit bot execution to be started from that point. For example, the entry class generator 1108 takes, as an input, a parent bot name, such “Invoice-processing.bot” and generates a Java class having a contract method with a predefined signature. A bot class generator 1110 can generate a bot class and orders command code in sequence of execution. The bot class generator 1110 can take, as input, an in-memory bot structure and generates, as output, a Java class in a predefined structure. A Command/Iterator/Conditional Code Generator 1112 wires up a command class with singleton object creation, manages nested command linking, iterator (loop) generation, and conditional (If/Else If/Else) construct generation. The Command/Iterator/Conditional Code Generator 1112 can take, as input, an in-memory bot structure in JSON format and generates Java code within the bot class. A variable code generator 1114 generates code for user defined variables in the bot, maps bot level data types to Java language compatible types, and assigns initial values provided by user. The variable code generator 1114 takes, as input, an in-memory bot structure and generates Java code within the bot class. A schema validator 1116 can validate user inputs based on command schema and includes syntax and semantic checks on user provided values. The schema validator 1116 can take, as input, an in-memory bot structure and generates validation errors that it detects. The attribute code generator 1118 can generate attribute code, handles the nested nature of attributes, and transforms bot value types to Java language compatible types. The attribute code generator 1118 takes, as input, an in-memory bot structure and generates Java code within the bot class. A utility classes generator 1120 can generate utility classes which are used by an entry class or bot class methods. The utility classes generator 1120 can generate, as output, Java classes. A data type generator 1122 can generate value types useful at runtime. The data type generator 1122 can generate, as output, Java classes. An expression generator 1124 can evaluate user inputs and generates compatible Java code, identifies complex variable mixed user inputs, inject variable values, and transform mathematical expressions. The expression generator 1124 can take, as input, user defined values and generates, as output, Java compatible expressions.

The JAR generator 1128 can compile Java source files, produces byte code and packs everything in a single JAR, including other child bots and file dependencies. The JAR generator 1128 can take, as input, generated Java files, resource files used during the bot creation, bot compiler dependencies, and command packages, and then can generate a JAR artifact as an output. The JAR cache manager 1130 can put a bot JAR in cache repository so that recompilation can be avoided if the bot has not been modified since the last cache entry. The JAR cache manager 1130 can take, as input, a bot JAR.

In one or more embodiment described herein command action logic can be implemented by commands 1001 available at the control room 808. This permits the execution environment on a device 810 and/or 815, such as exists in a user session 818, to be agnostic to changes in the command action logic implemented by a bot 804. In other words, the manner in which a command implemented by a bot 804 operates need not be visible to the execution environment in which a bot 804 operates. The execution environment is able to be independent of the command action logic of any commands implemented by bots 804. The result is that changes in any commands 1001 supported by the RPA system 800, or addition of new commands 1001 to the RPA system 800, do not require an update of the execution environment on devices 810, 815. This avoids what can be a time and resource intensive process in which addition of a new command 1001 or change to any command 1001 requires an update to the execution environment to each device 810, 815 employed in a RPA system. Take, for example, a bot that employs a command 1001 that logs into an on-online service. The command 1001 upon execution takes a Uniform Resource Locator (URL), opens (or selects) a browser, retrieves credentials corresponding to a user on behalf of whom the bot is logging in as, and enters the user credentials (e.g., username and password) as specified. If the command 1001 is changed, for example, to perform two-factor authentication, then it will require an additional resource (the second factor for authentication) and will perform additional actions beyond those performed by the original command (for example, logging into an email account to retrieve the second factor and entering the second factor). The command action logic will have changed as the bot is required to perform the additional changes. Any bot(s) that employ the changed command will need to be recompiled to generate a new bot JAR for each changed bot and the new bot JAR will need to be provided to a bot runner upon request by the bot runner. The execution environment on the device that is requesting the updated bot will not need to be updated as the command action logic of the changed command is reflected in the new bot JAR containing the byte code to be executed by the execution environment.

The embodiments herein can be implemented in the general context of computer-executable instructions, such as those included in program modules, being executed in a computing system on a target, real or virtual, processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may further include a device or product having content stored thereon at a time of sale or delivery. Thus, delivering a device with stored content, or offering content for download over a communication medium, may be understood as providing an article of manufacture with such content described herein.

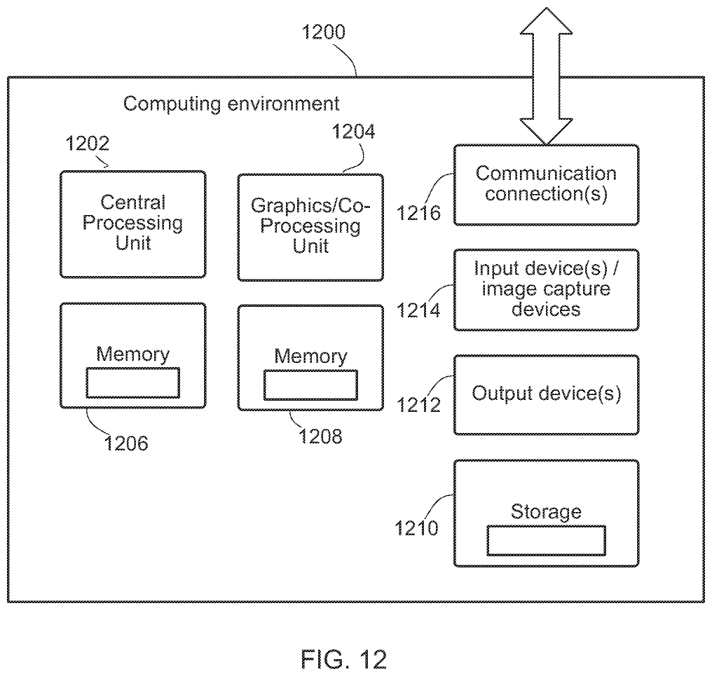

FIG. 12 illustrates a block diagram of an exemplary computing environment 1200 for an implementation of an RPA system, such as the RPA systems disclosed herein. The embodiments described herein may be implemented using the exemplary computing environment 1200. The exemplary computing environment 1200 includes one or more processing units 1202, 1204 and memory 1206, 1208. The processing units 1202, 1206 execute computer-executable instructions. Each of the processing units 1202, 1206 can be a general-purpose central processing unit (CPU), processor in an application-specific integrated circuit (ASIC) or any other type of processor. For example, as shown in FIG. 12, the processing unit 1202 can be a CPU, and the processing unit can be a graphics/co-processing unit (GPU). The tangible memory 1206, 1208 may be volatile memory (e.g., registers, cache, RAM), non-volatile memory (e.g., ROM, EEPROM, flash memory, etc.), or some combination of the two, accessible by the processing unit(s). The hardware components may be standard hardware components, or alternatively, some embodiments may employ specialized hardware components to further increase the operating efficiency and speed with which the RPA system operates. The various components of exemplary computing environment 1200 may be rearranged in various embodiments, and some embodiments may not require nor include all of the above components, while other embodiments may include additional components, such as specialized processors and additional memory.

The exemplary computing environment 1200 may have additional features such as, for example, tangible storage 1210, one or more input devices 1214, one or more output devices 1212, and one or more communication connections 1216. An interconnection mechanism (not shown) such as a bus, controller, or network can interconnect the various components of the exemplary computing environment 1200. Typically, operating system software (not shown) provides an operating system for other software executing in the exemplary computing environment 1200, and coordinates activities of the various components of the exemplary computing environment 1200.

The tangible storage 1210 may be removable or non-removable, and includes magnetic disks, magnetic tapes or cassettes, CD-ROMs, DVDs, or any other medium which can be used to store information in a non-transitory way, and which can be accessed within the computing system 1200. The tangible storage 1210 can store instructions for the software implementing one or more features of a PRA system as described herein.

The input device(s) or image capture device(s) 1214 may include, for example, one or more of a touch input device (such as a keyboard, mouse, pen, or trackball), a voice input device, a scanning device, an imaging sensor, touch surface, or any other device capable of providing input to the exemplary computing environment 1200. For multimedia embodiment, the input device(s) 1214 can, for example, include a camera, a video card, a TV tuner card, or similar device that accepts video input in analog or digital form, a microphone, an audio card, or a CD-ROM or CD-RW that reads audio/video samples into the exemplary computing environment 1200. The output device(s) 1212 can, for example, include a display, a printer, a speaker, a CD-writer, or any another device that provides output from the exemplary computing environment 1200.

The one or more communication connections 1216 can enable communication over a communication medium to another computing entity. The communication medium conveys information such as computer-executable instructions, audio or video input or output, or other data. The communication medium can include a wireless medium, a wired medium, or a combination thereof.

The various aspects, features, embodiments or implementations of the invention described above can be used alone or in various combinations.

Embodiments of the invention can, for example, be implemented by software, hardware, or a combination of hardware and software. Embodiments of the invention can also be embodied as computer readable code on a computer readable medium. In one embodiment, the computer readable medium is non-transitory. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

Numerous specific details are set forth in order to provide a thorough understanding of the present invention. However, it will become obvious to those skilled in the art that the invention may be practiced without these specific details. The description and representation herein are the common meanings used by those experienced or skilled in the art to most effectively convey the substance of their work to others skilled in the art. In other instances, well-known methods, procedures, components, and circuitry have not been described in detail to avoid unnecessarily obscuring aspects of the present invention.

In the foregoing description, reference to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method for detecting changes in one or more application programs that are utilized by a software robot, the method comprising:
forming a software robot that utilized at least one application program, wherein the software robot initiates interactions with the at least one application program on behalf of a user;
generating a design-time fingerprint associated with an application screen of the at least one application program that occurs during the forming of the software robot;
saving the software robot;
saving the design-time fingerprint in association with saved software robot;
subsequently starting execution of the software robot;
detecting presentation of an application screen of the at least one application program during execution of the software robot;
generating an execution-time fingerprint associated with the application screen of the at least one application program during execution of the software robot, if the detecting detects presentation of the application screen of the at least one application program during execution of the software robot;
comparing the execution-time fingerprint with the design-time fingerprint to produce comparison data; and
determining whether the at least one application program has changed based on the comparison data.

2. A computer-implemented method as recited in claim 1, wherein the method comprises:
issuing a notification if the determining whether the at least one application program has changed based on the comparison data.

3. A computer-implemented method as recited in claim 2, wherein the determining whether the at least one application has changed based on the comparison data comprises:
determining a degree of change to at least a portion of the at least one application program based on the comparison data; and
issuing the notification based on the degree of change.

4. A computer-implemented method as recited in claim 1,
wherein the application screen includes a plurality of elements, and
wherein the generating of the execution-time fingerprint associated with the application screen of the at least one application program during execution of the software robot comprises:
forming the execution-time fingerprint from a plurality of element fingerprints for the elements of the application screen.

5. A computer-implemented method as recited in claim 4, wherein the comparing the execution-time fingerprint with the design-time fingerprint to produce the comparison data is done on an element-by-element basis.

6. A computer-implemented method as recited in claim 4, wherein the determining whether the at least one application program has changed based on the comparison data comprises:
determining whether the application screen of the application program has added or removed one or more of the elements from the application screen.

7. A computer-implemented method as recited in claim 1,
wherein the application screen includes a plurality of elements, and one or more of the elements includes element properties, and
wherein the generating of the execution-time fingerprint comprises:
forming the execution-time fingerprint from a plurality of element fingerprints for the elements of the application screen, the element fingerprints are determined in part dependent on at least a subset of the element properties corresponding to the elements.

8. A computer-implemented method as recited in claim 7, wherein the comparison data indicates whether one or more of the element properties corresponding to at least one of the elements have changed.

9. A computer-implemented method as recited in claim 7,
wherein the comparing the execution-time fingerprint with the design-time fingerprint to produce the comparison data is done on an element-by-element basis, and
wherein the determining whether the at least one application program has changed based on the comparison data comprises:
determining whether at least one of the element properties of the elements have changed.

10. A computer-implemented method for detecting changes in an application program being utilized by a software robot during execution of the software robot, the software robot being supported by a robotic process automation system, the method comprising:
starting execution of the software robot;
detecting presentation of an application screen of the application program during execution of the software robot;
generating an execution application fingerprint associated with the application screen of the application program during execution of the software robot, if the detecting detects presentation of the application screen of the application program during execution of the software robot;
retrieving a saved application fingerprint that was previously saved for a corresponding application screen of the application program;
comparing the execution application fingerprint with the saved application fingerprint to produce comparison data; and
determining whether the application program has changed based on the comparison data.

11. A computer-implemented method as recited in claim 10, wherein the method comprises:
sending a notification to a user or owner of the software robot that the software robot is at least at risk for not executing correctly when interacting with the application program.

12. A computer-implemented method as recited in claim 10,
wherein the application screen includes a plurality of elements, and
wherein the generating of the execution application fingerprint associated with the application screen of the at least one application program during execution of the software robot comprises:
forming the execution application fingerprint from a plurality of element fingerprints for the elements of the application screen.

13. A computer-implemented method as recited in claim 12, wherein the comparing the execution application fingerprint with the saved supplication fingerprint to produce the comparison data is done on an element-by-element basis.

14. A computer-implemented method as recited in claim 12, wherein the determining whether the at least one application program has changed based on the comparison data comprises:
determining a degree of change to at least a portion of the at least one application program based on the comparison data.

15. A computer-implemented method as recited in claim 14, wherein the method comprises:
determining whether to issue a notification based on the degree of change.

16. A computer-implemented method as recited in claim 10, wherein the detecting presentation of an application screen of the application program during execution of the software robot comprises detecting a window event with respect to the application program induced by execution of the software robot.

17. A computer-implemented method as recited in claim 10, wherein the application program is a web-based application.

18. A computer-implemented method as recited in claim 10, wherein the method comprises:
determining where a change to the application screen of the application program has occurred when the determining determines that the application program has changed based on the comparison data; and
distinctively displaying an indication on the application screen where the change to the application screen has been determined.

19. A non-transitory computer readable medium including at least computer program code tangible stored therein for detecting changes in an application program being utilized by a software robot during execution of the software robot, the computer readable medium comprising:
computer program code for initiating execution of the software robot;
computer program code for detecting presentation of an application screen of the application program during execution of the software robot;
computer program code for generating an execution application fingerprint associated with the application screen of the application program during execution of the software robot, if the detecting detects presentation of the application screen of the application program during execution of the software robot;
computer program code for retrieving a saved application fingerprint that was previously saved for a corresponding application screen of the application program;
computer program code for comparing the execution application fingerprint with the saved application fingerprint to produce comparison data; and
computer program code for determining whether the application program has changed based on the comparison data.

20. A non-transitory computer readable medium as recited in claim 19, wherein the saved application fingerprint pertains to an application screen that is presumable the same application screen as the application screen of the application program during execution of the software robot.

21. A computer-implemented method for determining whether a software robot needs to be updated, the method comprising:
detecting presentation of an application screen of the application program during execution of the software robot;
generating an execution application fingerprint associated with the application screen of the application program during execution of the software robot, if the detecting detects presentation of the application screen of the application program during execution of the software robot;
retrieving a saved application fingerprint that was previously saved for a corresponding application screen of the application program;
comparing the execution application fingerprint with the saved application fingerprint to produce comparison data; and
determining whether the application program has changed based on the comparison data.
